(19) United States
(12) Patent Application Publication
(10) Pub. No.: US 2010/0149676 A1
(43) Pub. Date: Jun. 17, 2010

(54) THREE-DIMENSIONAL MAGNETIC RECORDING

(75) Inventors: Sakhrat Khizorev, Coral Gables, FL (US); Nissim Amos, Moreno Valley, CA (US); Rabee Ikkawi, Pembroke Pines, FL (US); Robert Haddon, Riverside, CA (US)

Correspondence Address: BUCHANAN, INGERSOLL & ROONEY PC, POST OFFICE BOX 1404, ALEXANDRIA, VA, 22313-1404, US

(73) Assignee: THE REGENTS OF THE UNIVERSITY OF CALIFORNIA, Oakland, CA (US)

(21) Appl. No.: 12/506,042

(22) Filed: Jul. 20, 2009

Related U.S. Application Data
(60) Provisional application No. 61/115,434, filed on Nov. 17, 2008.
(60) Provisional application No. 61/082,091, filed on Jul. 18, 2008.

(51) Int. Cl. G11B 5/127; G11B 5/673; G11B 5/02

(52) U.S. Cl. 360/55; 428/828.1; 360/110; G9B/5.041; G9B/5.026

(57) ABSTRACT

A multilayered three-dimensional media having a plurality of magnetic sublayers, each of the magnetic sublayers being separated from one another by a non-magnetic layer. The plurality of magnetic sublayers can be a stack of one or more coupled Co/Pd or Co/Pt layers; a layer of Co—Cr alloys optionally containing TiO₂, SiO₂, C, Pt, and B; a stack of one or more Co—Cr—Pt/Pt layers; a stack of one or more Co—Cr—Pd/Pd layers; and/or a stack of one or more layers of Fe—Pt, Fe—Pd, Co—Pt, and Co—Pd materials in an L1₀ phase. The non-magnetic layers are Pd, Pt, Ti, Ta, Cu, Au, Ag, MgO, or/and ITO. In addition, a multilayered three-dimensional recording system is disclosed, which includes a three-dimensional media, the three-dimensional media includes a plurality of magnetic sublayers, wherein each magnetic sublayer is adapted for writing data to; and a recording head having a trailing edge, and wherein the trailing edge has a higher permeability than the recording head.

### CROSS-REFERENCE TO RELATED APPLICATION

This application claims priority to U.S. Patent Provisional Application No. 61/082,091, filed Jul. 18, 2008, and U.S. Patent Provisional Application No. 61/115,434, filed Nov. 17, 2008, which are incorporated herein by this reference in their entirety.

### GOVERNMENT INTEREST

This invention was made with Government support under Grant (Contract) No. H94003-07-2-0703 awarded by Defense MicroElectronics Activity (DMEA) and Office of Naval Research (ONR). The Government has certain rights to this invention.

### FIELD OF INVENTION

The current invention refers to methods of developing multilevel three-dimensional (ML3D) recording systems which could be implemented in the form of a plug-in drive to replace conventional magnetic disk drive in computer and other applications. In accordance with an exemplary embodiment, using three (instead of two) dimensions allows recording, storing, and retrieving information with substantially higher areal densities and data rates compared to any state-of-the-art 2D memory technology. For example, with the proposed technology, the entire library of Congress could be recorded in a device the size of a quarter. The demand for more data has no limits and continues to exponentially grow. Ultra-high-density and super-fast memory is finding use in a wide spread of applications ranging from the Internet and broadband communications to rapidly growing mobile device applications.

### BACKGROUND

During the last couple of years, for the first time, researchers witness that the recorded data in conventional longitudinal magnetic media become highly unstable as the areal density increases beyond approximately 100 Gbit/in². To underscore the significance of the modern situation in the industry, it could be mentioned that for the first time the industry switched to a different technology perpendicular recording which is merely an incremental solution that promises only a factor of 2 to 3 increase in information density. Most of the other known alternative technologies, e.g. heat-assisted magnetic recording (HAMR) and patterned media, are of 2-D nature and promise to defer the superparamagnetic limit only somewhat beyond one terabit/in², not to mention that implementation of each of them has too many open questions. It is clear that to defer the superparamagnetic limit substantially beyond the one terabit/in² mark, at some point it will be necessary to start to stack recording layers in a third (vertical) dimension. The vertical stacking underlies the concept of 3-D magnetic memory—the primary subject of this invention. It can be appreciated that the invention has several forms and/or technology generations including both media and transducer development.

### SUMMARY

In accordance with an exemplary embodiment, a multilayered three-dimensional (3D) recording system, comprises: a three-dimensional (3D) media, the three-dimensional media includes a plurality of magnetic sublayers, wherein each magnetic sublayer is adapted for writing data to; and a recording head having a trailing edge, and wherein the trailing edge has a higher permeability than the recording head.

In accordance with another exemplary embodiment, a method of writing information into a three-dimensional media comprising: providing a three-dimensional media having a number of magnetic sublayers; and writing data onto the three-dimensional media with a recording head by continuously varying a drive current during at least one scan along a track to vary the depth of penetration in the magnetic sublayers of the three-dimensional media, and wherein reaching a sublayer in the three-dimensional media is obtained by exceeding the coercivity value in the sublayer, which is sufficient to reverse the magnetization required for recording information.

In accordance with a further exemplary embodiment, a method of reading information from a three-dimensional media comprises: providing a three-dimensional media having a number of magnetic sublayers with information thereon; and reading a stray field emanating from a bit location on a surface of the three-dimensional media.

In accordance with another exemplary embodiment, a method of reading magnetic information from a three-dimensional media comprises: providing a three-dimensional media having a number of magnetic sublayers with data thereon; and optically reading the data using a magneto-optical Kerr effect, wherein a polarized light passes through a region in the magnetic sublayers changes its polarization depending on the magnetization of the region.

### BRIEF DESCRIPTION OF THE DRAWINGS

FIG. 1 is a binary signal representation with a trivial FM encoding in (a) longitudinal and (b) perpendicular recording modes, and (c) a trivial example of a system with multilevel data encoding.

FIG. 2 is a schematic diagram illustrating how scaling has been applied to advance a technology to a next generation for the last 5 decades.

FIG. 3 is a schematic diagram comparing conventional longitudinal and perpendicular magnetic recording systems, in which the magnetization in the recording media is directed along the plane and perpendicular to the plane of the disk, respectively.

FIG. 4 is a comparison between a conventional recording system with recording on a surface (left) and a proposed 3-D or/and multi-level system with recording across the thickness of a recording media.

FIGS. 5(a)-(d) are schematics illustrating: (a) a recording across the thickness via continuous variation of the recording field, wherein the boundary curve is the field profile when H=H_{c}, where H_{c} is the coercivity; (b) a perpendicular recording system, including FIB images of FIB-fabricated; (c) a diasingle pole writer with a 80-nm trackwidth; and (d) a MFM nanoprobe for reading a component of the stray magnetic field.

FIGS. 6(a)-6(e) represent (a) an SEM image of electron beam lithography (EBL or E-Beam lithography) fabricated nanostructures with dimensions ranging from 30-500 nm; (b) and (c) represent SEM images of the various nanostructures after deposition of 2 decoupled magnetic layers with various dimensions and similar dimensions, respectively; (d) represents an AFM (bottom left)/MFM image which clearly shows 3 distinguishable signal levels both visually and on the sectional analysis; and (e) shows an atomic force microscope (AFM) (topography)/magnetic force microscope (MFM) image of the similar dimensions nanostructures which also show at least 3 signal levels.

FIGS. 7(a)-(d) illustrate schematics (not to scale) showing: (a) a Co/Pd stack in the conventional sense as used in perpendicular recording: Pd interlayers are approximately 0.5 nm thick; (b) a 3-D (3-dimensional) implementation of multilayers: with Co (top) and Co/Pd in the conventional sense (bottom) as “single” layers in a stack, wherein the micromagnetic simulations illustrating the effect of the interlayer spacing on the ability of the magnetization to follow the recording field profile; (c) wherein the interlayer spacing is approximately less than (<) 1 nm (strong exchange coupling); and (d) wherein the interlayer spacing is approximately greater than (>) approximately 1 nm (weak exchange coupling).

FIGS. 8(a)-(c) illustrate: (a) a schematic to illustrate the concept of creating a coercivity (or Curie temperature) gradient to improve the writing process, and Kerr signals for a 7-layer stack of Co/Pt multilayers with a composition of Pt(5 nm)/[Co(0.45 nm)/Pt(0.55 nm)]×7/Pt(2.5 nm)/Pd(2.5 nm) with coercivity of approximately 300 Oe (FIG. 8(a)), and a 7-layer stack of Co/Pd multilayers with a composition of Pt(2.5 nm)/Pd(2.5 nm)/[Co(0.25 nm)/Pd(0.55 nm)]×7/Pd(5.3 nm) with coercivity value of about 3800 Oe (FIG. 8(b)).

FIG. 9 is an illustration of Kerr measurements indicating that two stacks within a 3D media are “exchange” decoupled, and wherein the media is composted of a dual stack of Co/Pt and Co/Pd multilayers with the following composition: Pt(5 nm)/{Co(0.45 nm)/Pt (0.55 nm)]×7/Pt(2.5 nm)/Pd(2.5 nm)/{Co(0.25 nm)/Pd(0.55 nm)]×7/Pd(5.3 nm).

FIGS. 10(a)-(b) are schematics illustrating 3D recording systems with a single pole head (a—left) and a ring head (b—right).

FIGS. 11(a)-(b) are diagram illustrating: (a) sequential recording of different levels in a 3-D patterned media; and (b) The recording field profiles in the first, second, and third layers at a given value of the drive current in the recording transducer above the cell.

FIGS. 12(a)-(c) illustrate: (a) the “charge” representation of different digital values in the bit cell consisting of many magnetic layers; (b) the stray field versus the digital level in the 3-d multi-level mode; and (c) SNR versus the number of layers.

FIG. 13 illustrates the readback signal (in a GMR sensor) from different information states.

FIGS. 14(a)-(b) is an illustration of the effect of using a laminated single pole head to record into a 3D media wherein (a) and (b) show head structures and field profiles without and with an additional trailing layer made of a material with higher magnetic permeability, respectively and the dark (red) color indicates the region where the recording field exceeds the coercivity of the media, and the relatively permeability of the trailing layer, μ₁, substantially exceeds the permeability of the rest of the pole, μ₂.

FIG. 15 is a field “penetration” into 3D media by gradually increasing the current through the drive coil, wherein as the current is increased to the value I₁ the recording field exceeds the coercivity in Layer 1 (or “penetrates” in Layer 1), and as the current is further increased, consequently the field is increased to exceed the coercivity of the media in Layer 2, i.e. the field “penetrates” also in Layer 2.

FIG. 16 illustrates the recording field versus the drive current for a four-layer 3D recording system according to the current invention.

FIG. 17 is a schematic illustrating the process of recording into 3D media with a ring head with a laminated trailing pole.

FIGS. 18(a)-(b) are diagrams showing: (a) a bi-layer trailing pole structure; and (b) reluctance model to describe the flow of magnetic flux through a laminated pole.

FIGS. 19(a)-(b) are schematics of 3D systems with 3D media with (a) a continuous soft underlayer (SUL) and (b) a patterned SUL.

FIGS. 20(a)-(c) are recording field profiles for three systems: (a) without a SUL, (b) with a continuous SUL; and (c) a patterned SUL, respectively, and wherein a darker red color indicates a stronger recording field.

FIG. 21 is a schematic to illustrate the definition of a track.

FIGS. 22(a)-(b) are cross-section diagrams (not to scale) illustrating the process of recording into 3D media through the multi-scan process with the information recorded into different layers during different scans of a track, and wherein (a) recording into the bottom layer (Layer N) with the recording field exceeding the coercivity in Layer N during recording scan 1; and (b) recording into the next to the bottom layer (Layer N−1) with the recording field exceeding the coercivity in Layer N−1 while weaker than the coercivity in Layer N during recording scan 2.

FIG. 23 is a full hysteresis loop of a three-layer ML3D media measured with Kerr magnetometry, wherein the three arrows indicate the magnetization in the three layers, respectively.

FIGS. 24(a)-(c) are schematics showing the magnetization directions in the three layers of a 3-layer ML3D media during: (a) a full hysteresis loop to choose levels 1 to 6; (b) a minor loop to choose level 7; and (c) a minor loop to choose level 8.

FIGS. 25(a)-(b) are illustrations of the principle of differential reading with (a) a trivial differential reader including a magnetoresistive element (GMR, TMR, etc) and an independent “soft” layer; and (b) a magnetoresistive element integrated with the trailing soft pole of the recording head, and wherein in the latter case, the trailing pole is used as the “soft” shield necessary to enable the differential mechanism.

FIGS. 26(a)-(b) are schematics of (a) a differential reader and (b) a differential pair incorporated by shields integrated in a 3D system.

FIGS. 27(a)-(b) are schematics to illustrate optical reading of information from 3D media in (a) a reflection mode and (b) a transmission mode.

FIG. 28(a)-(b) are schematics to illustrate optical reading of information from 3D media in accordance with another embodiment.

FIG. 29 is an illustration showing the clearance (fly height) between the head and media versus the voltage (top) and power of the heater.

FIG. 30 is an illustration of the concept of writing into ML3D media with multiple heads.

FIG. 31 is an illustration of the concept of parallel reading from ML3D media with multiple heads.

FIGS. 32(a)-(b) are (a) an illustration of 8 signal levels resulting from a 3-layer 3D media (not to scale); and (b) an experiment clearly indicated 8 signal levels coming from a 3-level 3D media.

FIG. 33 is a characteristic graph which shows a numerical simulation of the recording field generated by four different recording poles with the same width of 60 nm.

FIG. 34 is a schematic illustration showing the layer structure of 4 magnetically decoupled Co/Pd multilayers stacks in which the top layer has the lowest coercivity and magnetic moment and the bottom layer has the highest coercivity and the highest moment, and wherein the magnetic moment and coercivity are interchangeable and depend on the fabrication conditions (left), and a Kerr signal taken from a 4 layer media, which shows the characteristics of a 16 readback signal level media (right).

### DETAILED DESCRIPTION

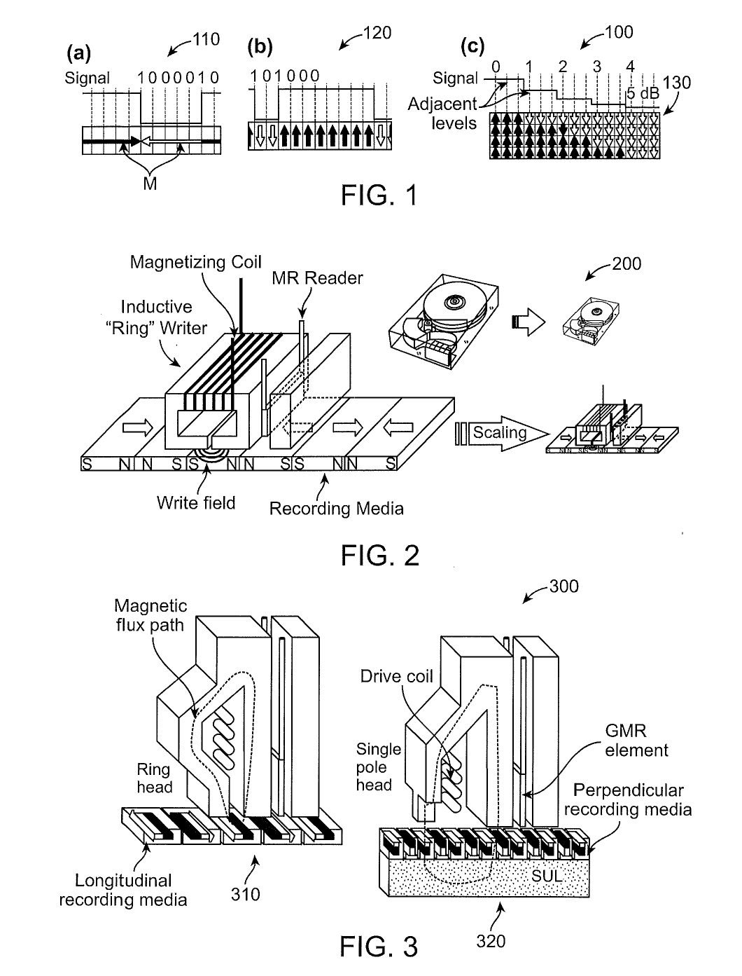

In accordance with an exemplary embodiment, the concept of multilevel (ML) 3D magnetic recording relies on using more than two signal levels to code recorded information. This is in contrast with conventional recording schemes in which they use binary coding methods, meaning that the signal recorded into or read back from magnetic media has only two states: presence or absence of the magnetization reversal in a bit transition. For example, FIGS. 1(a) and 1(b) illustrate the concept of so called frequency modulation (FM) encoding 100, as it can be used in longitudinal 110 and perpendicular recording 120, respectively. The only difference between the two recording modes is in the orientation of the magnetization, which is along or perpendicular to the plane of the disk, respectively. In both cases, encoding has a simple one-to-one correspondence between the bit to be encoded and the magnetization reversal pattern.

ML magnetic recording refers to the use of multiple signal values to encode data onto a magnetic disk. By using more than two levels, more information can be put in the minimum feature size. FIG. 1(c) illustrates how a multilevel code could be used in a system 130 with a 3D media with a perpendicular orientation of the magnetization. This is a simplified case; in general, the magnetization could be oriented along or at some arbitrary angle to the plane of the disk. As described below in more detail, it would be desirable to engineer and/or design a magnetic recording system which could maintain signal-to-noise ratio (SNR) between any two adjacent levels sufficient for a data encoding channel while maintaining a certain data bit error rate. In accordance with an exemplary embodiment, the multilevel data coding methods discussed below are designed to deal with a signal-to-noise ratio (SNR) of approximately 5 dB. Therefore, it would be disable to develop and/or engineer a practical ML recording system with as many levels as possible, and a magnetic recording system with as many signal levels as possible with at least 5 dB SNR between any two adjacent levels. In addition, it would be desirable to design and/or engineer an ML approach that can be applied to any of the above mentioned alternative technologies to further increase the data capacity.

### History of Multilevel Optical Recording

Before exploring the feasibility of ML magnetic recording, it may be helpful to learn from the experience of other industries with regard to ML data coding. For example, in 2004, one of the electronics giants LSI Logic acquired Calimetrics—the first company which focused on the development of a multilevel optical recording system for CD or DVD technologies. Though Calimetrics ceased to exist mostly because of the suddenly raised popularity of writable DVD technology, it was successful in introducing a multilevel signal standard in the world of information related technologies, especially overseas. Today, it is becoming normal for new technologies to start to prosper first overseas where it is often easier to launch new standards because of the lack of a well-established traditional technology infrastructure. Although the ML technology by Calimetrics offered only 8 signal levels and was not rewritable, it still appeared successful especially in its tremendous impact on modern DVD technologies.

However, it can be appreciated that differences between ML 3D magnetic recording and ML optical technology exist, which include (a) the ML technology developed by Calimetrics competed in the market of DVD/CD technologies while the analyzed ML magnetic technology, at least at this early stage, is targeting the market of hard drives; (b) the Calimetrics technology was optics-based while the exemplary embodiment technology is magnetics-based. Consequently, the magnetic technology would be rewritable, which is in contrast with the read-only Calimetrics technology; and (c) the optical technology used only 8 signal levels while the ML magnetic technology has potential for over 1000 levels.

### Magnetics of Multilevel 3D Recording

Traditionally, scaling laws have been followed to advance magnetic data storage industry to a next level/generation. Scaling implies that with each next generation, all dimensions of a recording system 200 have been respectively reduced, as schematically illustrated in FIG. 2. Such a straightforward approach (of scaling) has been applied since the inception of the data storage industry near half a century ago. Today, for the first time since the inception of the data storage, the traditional technology cannot be further improved as a result of the superparamagnetic limit. This fundamental limit is caused by thermal instabilities in the recording media when physical bit dimensions are reduced below certain fundamental values. The modern laboratory demonstrations indeed indicate that the information becomes highly unstable as the areal density is increased approximately above 200 Gbit/in².

It can be appreciated that perpendicular recording may defer the fundamental superparamagnetic limit for several more years, and which could bring the areal densities in demonstration data storage systems hopefully to one terabit-per-square-inch. FIG. 3 illustrates 300 the difference between the conventional technology 310 (longitudinal magnetic recording) and perpendicular recording 320. In the case of perpendicular recording 320, the magnetization in the disk is polarized perpendicular to the disk. This is in contrast with the conventional system in which the magnetization is polarized along the disk. According to a model in layman's terms, each bit of information is presented as a permanent magnet. Depending on the direction of the magnetic moment inside the magnet, the recorded information is “0” or “1”. According to this model, one could pack more permanent magnets per unit surface area in the configuration when the magnet's axis is directed perpendicular to the disk rather than in the plane of the disk.

Unlike many other alternatives to the conventional recording (such as, for example, heat-assisted magnetic recording (HAMR) and patterned media), perpendicular recording has been quickly adopted by the industry because of its similarity to the conventional technology. For example, during the last two years, most leading companies in the industry have transitioned to perpendicular recording. Perpendicular recording is expected to defer the superparamagnetic limit to approximately 1 Terabit/in². Alternatively, with multilevel 3D recording, in accordance with an exemplary embodiment, areal densities above 10 Terabit/in² are desirable.

### Multilevel 3D Recording

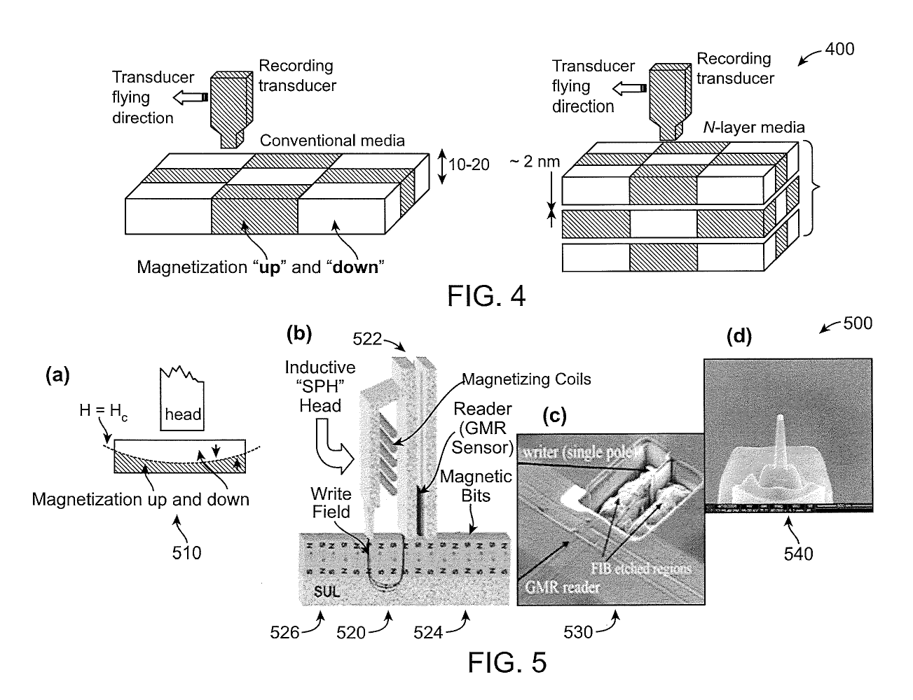

The concept of three-dimensional (3D) magnetic recording was proposed about ten years ago. The technology is different from the traditional approach to deal with one surface (of the recording media) only. Instead, a third vertical dimension is used to store information not only on the surface but also in the volume of the recording media 400. In other words, the information is packed also across the thickness, as shown in FIG. 4. As a result, more than one signal level can be exploited to record, store, and retrieve information from the same unit surface area of the recording media. Accordingly, this opens a new window of opportunities not only to develop the most superior near-future data storage device (multilevel 3D (ML3D) drive) but also for a long future to exploit groundbreaking advantages of an entirely new dimension. It can be appreciated that in accordance with an exemplary embodiment, ML3D can be developed into multilevel magnetic logic systems and single-chip computing devices capable of ultra-high densities and ultra-fast data rates with negligible power consumption during write/read cycles.

In accordance with an exemplary embodiment, several advantages of a ML3D systems include a) the technology merits due to 3D magnetics and multilevel signal, b) simplicity, and c) potential as discussed below in more detail. As mentioned above, this is the only magnetic technology which relies on the use of a third dimension to record, retrieve and store information in a device. In other words, the information will be recorded not only on a surface but also across the thickness or in the volume of the recording media. As a result, substantially more information could be recorded per unit area and thus the fundamental data density limit could be extended substantially further. In addition, the exploitation of multi-level signal will substantially loosen fabrication requirement. In other words, unlike conventional magnetic and silicon technologies, this effort won't be limited by the many problems arising during fabrication of sub-100-nm devices. In this context, “multilevel” implies the ability to record more information per unit surface area.

Another advantage, is the relative simplicity of multilevel 3D recording, which is due to the fact that this technology has some similarity with perpendicular recording. Similar to perpendicular recording, the information, at least at the initial stage, will be recorded perpendicular to the disk. However, other media configurations can not be disregarded. For example, longitudinally oriented media or media with the magnetization tilted at some arbitrary angle may have some advantages perpendicular media don't have. As the complexity of multilevel 3D recording system increases with each next generation, it can be appreciated that some benefit can be obtained to eventually switch to one of the non-perpendicular modes.

In addition, because of the two obvious technology merits, 3D magnetics and multilevel signal configuration, respectively, the technology has long-term future potential compared to any other alternative data storage technology. While 2D technologies are in the end of their roadmaps, the described ML3D technology is just in the beginning of its roadmap. In accordance with an exemplary embodiment, a varying recording field 510 can be used to sequentially record across the media thickness, as illustrated in FIG. 5(a). In accordance with an exemplary embodiment, the 3D media configuration is similar to the popular perpendicular media configuration (with the magnetization perpendicular to the plane of the disk). For example, to generate adequate perpendicular field, a recording system 520 with a single pole head 522 and a recording media 524 with a soft underlayer (SUL) 526 can be used (FIG. 5(b)). In accordance with an embodiment the soft underlayer (SUL) 526 can be used to force the magnetic flux to flow in the perpendicular direction. Typical FIB-modified write head with a 80-nm trackwidth and a magnetic force microscopy (MFM) nanoprobe used to write 530 and read information 540 from 3-D media, respectively, are shown in FIGS. 5(c) and (d), respectively. The write head was in the form of a single pole, while the MFM nanoprobe can be designed to read a certain component of the magnetization.

Logic operations such as AND, OR, NOT, etc. can also be performed using the ML3D system. In this system, the multilevel signals can be attributed to particular logic operations. For example, considering the most trivial case of having a two-stack magnetic media for which each stack has a distinguishable coercivity value, the first string of bits can be recorded on the layer exhibiting the higher coercivity value with a relatively large magnetic field followed by the recording of the second string of bits (directly above the first string of bits) using the lower coercivity field value. The read-back signal is thus proportional to the superposition of the signals emanating from both magnetic layers and the interpretation of this signal may be read in a particular fashion in order to perform the different logic operations on the two strings of bits.

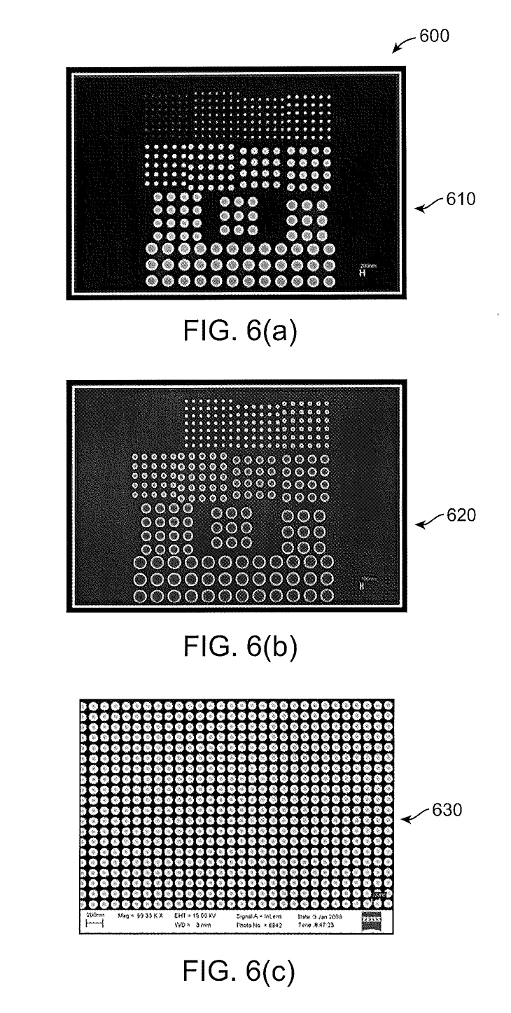

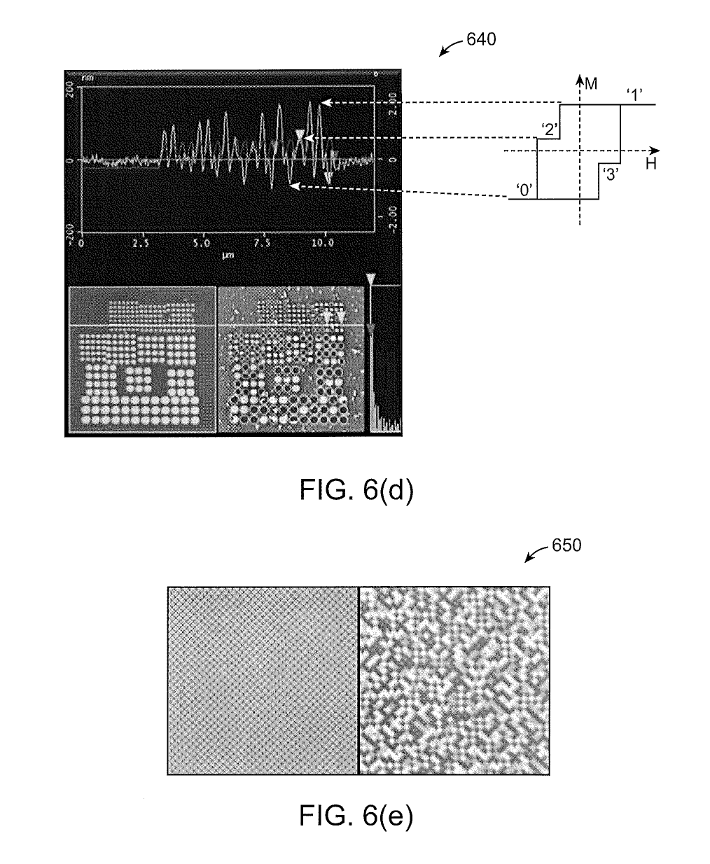

For example, the layers can be deposited via E-Beam lithography based pre-patterned media as shown in FIGS. 6(a)-6(e). For example, FIG. 6(a) shows an SEM image 610 of electron beam lithography (EBL) fabricated nanostructures with dimensions ranging from 30-500 nm. FIGS. 6(b) and (c) represent SEM images 620, 630 of the various nanostructures after deposition of 2 decoupled magnetic layers with various dimensions and similar dimensions, respectively. FIG. 6(d) represents an AFM (bottom left)/MFM image 640, which clearly shows 3 distinguishable signal levels both visually and on the sectional analysis. FIG. 6(e) shows an atomic force microscope (AFM) (topography)/magnetic force microscope (MFM) image 650 of the similar dimensions nanostructures which also show at least 3 signal levels. In accordance with an exemplary embodiment, the magnetic layers (or sublayers) can be deposited by E-Beam lithography. For illustration purposes, E-Beam lithography utilizes a beam of electrons, which can be scanned in a 3D pattern fashion across a surface covered with a resist, and of selectively removing either exposed or non-exposed regions of the resist.

Alternatively, in accordance with another exemplary embodiment, the magnetic layers (or sublayers) can be deposited via regular sputtering systems. Continuous and patterned versions of 3D media could be used. For illustration purposes, a focused ion beam (FIB) can be used to further pattern 3D media within the plane of the disk. A straightforward MFM experiment can be performed to demonstrate the presence of more than one signal levels. In accordance with an exemplary embodiment, a continuous CoCrPt-based 3-layer 3D media can be sputter-deposited and then patterned via FIB into a square periodic arrays with a linear period of 80 nm. Then, the media can be demagnetized using an alternating decaying external magnetic field.

It can be appreciated that this experiment illustrates that 3D media can be partially polarized across the thickness thus resulting in a multilevel signal configuration. On the contrary, it is known that in conventional recording the magnetization remains in one of the two saturated states and no partial polarization is feasible. To further perfect the concept of generating a multilevel signal, various mechanisms have been developed and explored. In accordance with an exemplary embodiment, one of the general tasks is to maximize the number of signal levels while maintaining signal-to-noise ratio (SNR) between the signal values in each pair of adjacent levels above approximately 5 dB. In accordance with an embodiment, the 5 dB value is dictated by the requirements of the novel data coding methods, as described below. In addition, it can be appreciated that in accordance with an exemplary embodiment, it would be desirable to develop a media in which each magnetic grain could be recorded independently (without a chain clustering effect). For example, a conventional CoCr-based composition (as used in conventional longitudinal recording media) can be used for this purpose as well and the media could be made even thicker to fully maximize the effective number of individual Co grains participating in the process.

### 3D Media Based on Co/Pd or Co/Pt Multilayers

In accordance with an alternative exemplary embodiment, a conventional Co/Pd (or Co/Pt) multilayer structures with strong surface-induce perpendicular anisotropy can be used. The adequately high perpendicular anisotropy is one of the key properties pursued in the design of a perpendicular recording system. Similarly, the “3-D magnetic media” can be fabricated as a stack of magnetic layers (or sublayers) separated from each other by thin non-magnetic interlayers 410, as shown in FIG. 4. In each set, the layer (or sublayer) 420 and the interlayer 410 are approximately 5 nm to 10 nm, and preferably greater than 1 nm to 2 nm thick, respectively. It can be appreciated that material choices can include high-anisotropy Co/Pd (Pt) perpendicular multilayers or others. In addition, it can be appreciated that one difference between Pd (Palladium) and Pt (Platinum) is purely quantitative. Although, Platinum (Pt) provides a better exchange coupling, Platinum (Pt) is also more expensive than Palladium (Pd). These multilayers, however, should not be confused with Co/Pd (Pt) multilayers as used in perpendicular recording.

In accordance with an exemplary embodiment, one of the purposes of some of the interlayers, Pd (Pt), is to break the quantum “exchange” coupling between the adjacent stacks of strongly coupled multilayers (within each stack) and thus to independently record information into the separate stacks. In accordance with an exemplary embodiment, each stack can consist of one or more pairs of strongly coupled Co and Pd (or Pt). Effectively, each stack acts as an individual magnetic layer in the sense that the magnetization is always in the same direction in each Co layer within the stack. The interface provides the perpendicular anisotropy. The more interfaces (or pairs) that are used the stronger the signal. However, it can be appreciated that the quality of the interface can suffer with the increase of the number of layers (or sublayers). In addition, it would be desirable to minimize the net thickness of 3D media with maximizing the number of effective stacks.

In accordance with an exemplary embodiment, assuming perpendicular magnetic anisotropy, the magnetization in the adjacent stacks can be directed in opposite directions because of the lack of adequate exchange coupling. The lack of the exchange coupling is due to the sufficiently thick quantum-mechanical exchange breaking interlayer (greater than (>) approximately 1-2 nm). Otherwise, due to the exchange coupling, all the layers (or sublayers) in a bit cell would have magnetization directed in one direction. The latter occurs in the multilayers as used in perpendicular recording. In the traditional case, the interlayer separation is chosen to be less than (<) approximately 1 nm to maximize the exchange coupling between the adjacent layers and thus increase the perpendicular anisotropy due the strong surface-induced anisotropy. This difference between Co/Pd (Pt) multilayers, as used in the conventional perpendicular mode and in the proposed 3-D implementation, is described below in more detail.

It can be appreciated that for the described 3-D implementation; it is not desirable to increase the thickness of Pd (Pt) non-magnetic layers to break the exchange coupling between the adjacent Co layers. In accordance with an exemplary embodiment, if the Pd layers are not adequately thin, the surface effects would be substantially reduced and thus the magnetic anisotropy would be determined by the interplay of intrinsic crystalline and shape anisotropy rather than by the surface-induced anisotropy. However, it can be appreciated that with an adequately high quality process, this may not be a problem. For example, in accordance with an exemplary embodiment, an interface between Co and Pd (Pt) may be sufficient to induce adequately strong perpendicular anisotropy. Alternatively, one interface may not be enough for certain applications.

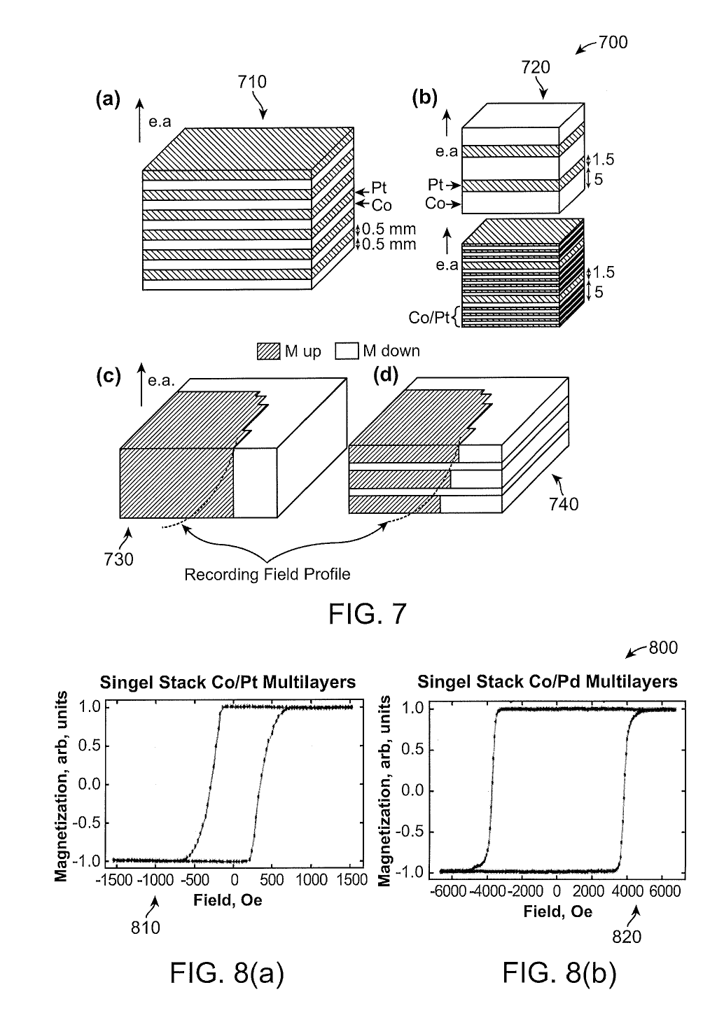

In accordance with an exemplary embodiment, Co/Pd (Pt) multilayers 700 can be used instead of the individual Co layers. In this embodiment, adjacent “single” magnetic layers (Co/Pd multilayers in the conventional sense) are separated by a relatively thick (greater than (>) approximately 1 nm) Pd interlayer to break the exchange coupling between the “single” layers 720, as shown in FIG. 7(b). FIG. 7(a) shows an equivalent conventional case 720. Here, it can be appreciated that other choices of materials are feasible provided the above described logic is followed.

In accordance with an exemplary embodiment, to simulate the grain interactions in 3-D media, a micromagnetic code can be used. In this simulation, a 3-D media is represented as a stack of alternating magnetic and non-magnetic layers with each layer consisting of interacting grains (in the form of a simplified square mesh). The short-range exchange coupling between adjacent grains and the long-range magnetostatic coupling between grains are described through the Landau-Lifshits-Gilbert (LLG) formalism. Each square grain had a 3-nm side and a thickness equal to the respective layer's thickness. In accordance with an exemplary embodiment, as the magnetic layers, conventional Co/Pd-multilayers were modeled with an anisotropy constant, K, of 5×10⁵ erg/cc, saturation magnetization of 250 emu/cc, and coercivity field of 8 kOe. The relative exchange coupling constant, hₑ, was modeled to be anisotropic: with the in-plane and perpendicular-to-the-plane exchange constants equal to 0.1 and 0.5, respectively.

FIG. 7(c) shows a micromagnetically simulated magnetization pattern 730 after applying the recording field from a single pole head to a stack of multilayers with an interlayer separation (Pd layer thickness) of less than one nanometer. The field from the single pole head was also modeled micromagnetically. In accordance with an exemplary embodiment, the stack of multilayers were made of a high moment FeAlN amorphous alloy with an anisotropy field, Hₖ, of 15 Oe, saturation magnetization, 4πMₛ, of 20 kG, and an exchange constant, A, of 10⁻⁶ erg/cm. Before applying the recording field, the media was saturated in the opposite direction. In accordance with an embodiment, it was observed that the magnetization pattern in the media did not follow the curved profile of the recording field, which can be explained by the relatively strong exchange coupling between the adjacent magnetic layers. Because of the strong coupling, the magnetization appears uniform across the thickness. In accordance with an exemplary embodiment, this is exactly the case in the conventional implementation of Co/Pd multilayers in perpendicular magnetic recording. It can be appreciated that in the two plane directions, the inter-granular exchange interaction was modeled to be substantially weaker so that individual bit cells could be defined in the plane. In contrast, in the proposed 3-D implementation, the interlayer thickness was chosen sufficiently thick to break the exchange coupling so that the magnetization pattern could follow the profile of the recording field and thus each grain within the disk plane and across the thickness could be accessed independently 740, as illustrated in FIG. 7(d). In accordance with an exemplary embodiment, the simulation indicated that the interlayer (Pd) thickness should be approximately greater than (>) 1 nm for the exchange coupling to be sufficiently weak.

In accordance with an exemplary embodiment, if there are approximately one thousand “individual” layers and the cross-section of each cell is approximately 80×80 nm², this type of 3-D media could store the amount of information in the 100 Tbit/in² density range and even more in the patterned form of 3-D media, as explained below. In addition, it can be appreciated that the effective areal density is limited not by the maximum capacity of the recording media, but rather by the mechanisms of data recording and retrieval.

It can be appreciated that due to the 3-D approach, the bit cell cross-section does not have to be ultra-small to achieve relatively high densities. In fact, no ultra-sophisticated nanofabrication tools may be necessary to achieve areal densities exceeding what is projected to be achieved within the next decade with 2-D recording systems (e.g., heat-assisted magnetic recording (HAMR)) using E-beam or focused ion beam (FIB). In the case of ML3D, the effective density can be achieved just via the deposition of a stack of layers. For example, an arrangement with a bit cell with a 160×160 nm² cross-section and a stack of 20 “independent” layers would be equivalent to an effective areal density of approximately 500 Gigabit/in². For example, to achieve a 160×160 nm² bit cell cross-section, UV-optical lithography is more than sufficient. However, as more advanced fabrication methods, such as E-beam and FIB-based and imprint lithography are used, the areal densities can increase beyond 1 Terabit/in².

### Using Soft Underlayer and Interlayers to Increase the Number of Layers in 3D Media

In accordance with a previous embodiment, it was shown that one approach to increase by a factor of approximately, the effective recording and sensitivity field can be through using a patterned soft underlayer (PSUL) or even patterned soft interlayers (PSUI). It can be appreciated that one of the practical advantages due to the use of a PSUL can include (a) SNR drastically increases as a result of patterning a SUL; (b) patterning of SUL increases both the recording and sensitivity field gradients, which can be critical for maximizing the areal density during writing and reading, respectively; and (c) the recording and sensitivity fields remain well localized across the entire thickness to generate a multitude of signal levels.

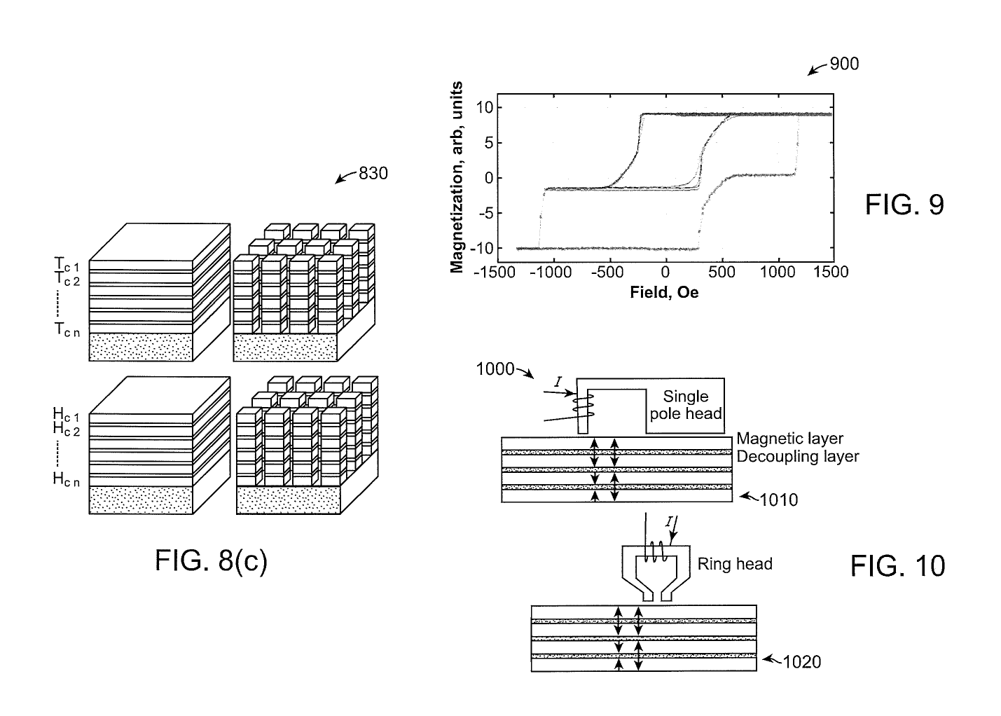

As previously mentioned, multilevel 3D magnetic recording can improve the data capacity of any of the proposed alternate technologies. In the case of HAMR, a localized light spot in the order of tens of nanometer is focused in the near field regime in order to effectively though instantaneously reduce the coercivity of highly anisotropic material, such as, for example, FePt-L10 material. Since the stability of each recorded bit is directly proportional to the effective anisotropy of the material and the effective volume of each grain, it is possible to substantially scale down the grain size and thus increase the areal density in a HAMR system. Using multilevel 3D recording can also increase the areal density by fabricating media 800 in which isolated magnetic layers exhibit a range of Curie temperatures, resulting in Curie temperature gradient across the thickness 830 of the 3D media (FIG. 8(c)). For example, in accordance with an exemplary embodiment, such media can be fabricated by varying the composition of FePtX, where X could be Cu, Ag, Au, Pd, or Cr. Moreover, the interlayers in this media will act both as exchange decoupling layers and good heat conductors. For example, in accordance with an exemplary embodiment, MgO can be used for both requirements. The separation between magnetic signal levels emanating from each layer and the localization of heat transfer could be further improved by patterning the media. Finally, recording of each layer within the bulk of the material can be achieved by modulating a particular magnetic field strength with certain light power.

### Creating Coercivity Gradient Across the Thickness of 3D Media to Increase the Number of Layers

Another way to effectively increase the number of individual layers would be through creating a gradient of the coercivity across the thickness of 3D media. In accordance with an exemplary embodiment, one mechanism to vary the coercivity in a Co/Pd-based 3D media 800 is through variation of the thicknesses 830 of Co and Pd layers in each Co/Pd pair across the media thickness, as shown in FIG. 8(c). FIGS. 8(a)-(b) illustrate the magnetic Kerr signals for a 7-layer stack of Co/Pt multilayers with a composition of Pt(5 nm)/[Co(0.45 nm)/Pt(0.55 nm)]×7/pt(2.5 nm)/Pd(2.5 nm) with coercivity of approximately 300 Oe (FIG. 8(a)), and a 7-layer stack of Co/Pd multilayers with a composition of Pt(2.5 nm)/Pd(2.5 nm)/[Co(0.25 nm)/Pd(0.55 nm)]×7/Pd(5.3 nm) with coercivity value of about 3800 Oe (FIG. 8(b)). It can be appreciated that the coercivity value for these multilayer structures can vary from approximately 300 Oe, which is the coercivity of a pure Co, to over 10 kOe, depending on the extent of the “exchange” coupling between two adjacent magnetic layers.

To illustrate the concept of varying coercivity, in accordance with an exemplary embodiment, Co/Pd multilayer-based 3D media was fabricated with two distinct stacks of two different values of coercivity, 300 and 3500 Oe, respectively. As shown in FIG. 9 is an illustration of Kerr measurements indicating that two stacks within a 3D media are “exchange” decoupled, and wherein the media is composted of a dual stack of Co/Pt and Co/Pd multilayers with the following composition: Pt(5 nm)/{Co(0.45 nm)/Pt(0.55 nm)]×7/Pt(2.5 nm)/Pd(2.5 nm)/{Co(0.25 nm)/Pd(0.55 nm)]×7/Pd(5.3 nm). The Kerr measurements 900, as shown in FIG. 9, indicate that indeed the experimental curve was similar to the theoretical curve in the assumption that the two stacks are not coupled in the quantum-mechanical sense, or, in other words, “exchange”-decoupled.

In accordance with an exemplary embodiment, at least over six layers (or over 26=64 signal levels) can be independently accessed in the above described manner. As previously mentioned, using a different type of media and such signal enhancing mechanisms as the integration with a patterned soft underlayer even soft interlayers and others might further increase signal to noise ratio (SNR) in 3D recording systems.

In accordance with an embodiment, several implementations of a 3-D memory device can be obtained. In accordance with an exemplary embodiment, E-Beam lithography can be used to fabricate a prototype with sub-100-nm dimensions. Alternatively, in accordance with another embodiment, a focused ion beam (FIB) can be used to fabricate a prototype with sub-100-nm dimensions. One of the proposed mechanisms to access data takes advantage of a E-Beam lithography and/or FIB-developed methods is to control strong magnetic fields using a “soft” magnetic underlayer (SUL) under the 3-D recording medium. During the write process, the use of a SUL allows to substantially increase the recording field across the entire thickness of the 3-D medium. During the readback process, the magnetic “softness” of the SUL strongly influences the sensitivity of each read element and thus will be used as a mechanism to identify a uni-field plane (2-D layer).

### Patterning of 3D Media

In accordance with an exemplary embodiment, to minimize the inter-symbol interference and improve stability, the recording medium can be patterned in all three dimensions. It can be appreciated that in an exemplary embodiment, the integration side of multilevel 3D (ML3D) recording can be addressed. Unlike earlier work, which focused on certain 3D media configurations, in accordance with an exemplary embodiment, the invention relates to the integration side of multilevel 3D (ML3D) recording, and the designing a ML3D recording systems including a recording head, a 3D media, and a data channel, as a whole.

As described in the previous section to enable multilevel 3D recording, it was proposed to use a certain 3D media configuration 1000, as illustrated in FIG. 10. FIG. 10 shows potential implementations with single pole head (left) 1010 and ring head (right) 1020. These two types of heads are used in perpendicular and longitudinal recording, respectively. In the case of single pole head, they often use a soft magnetic underlayer (SUL) to close the magnetic path for the flux generated by the drive current. It should be mentioned that though a ring head is typically used along with a longitudinal recording media, it also can be used in combination with a perpendicular recording media. The illustrations in the figures are not to scale. In actual implementations, 3D media could be as thin as 50 nm or so only.

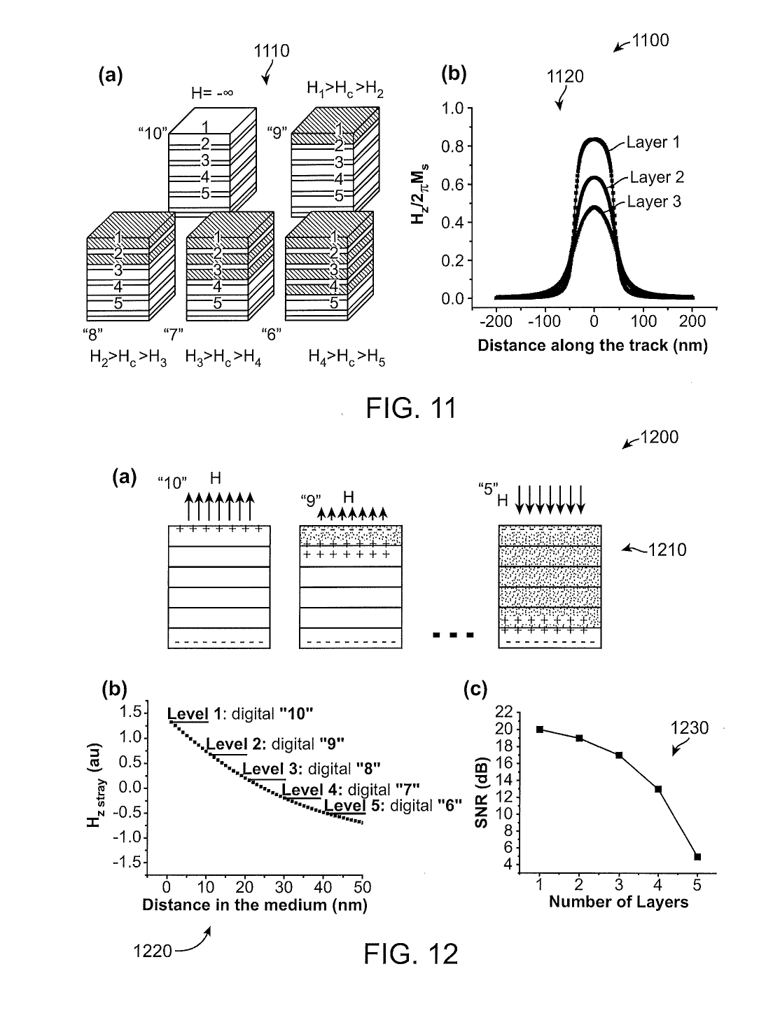

In such an implementation, the recording process is produced by continuously varying the drive current I. By gradually increasing the current from zero to some large value, the information can be gradually recorded in individual layers across the 3D media starting with the top (closest to the recording head) and finishing the bottom layer, as described above and illustrated in FIG. 5(a). As illustrated in FIG. 11, as the drive current is increased, the recording field is also increased starting with the top layer and ending with the bottom layer because the recording head is positioned closer to the top layer in this configuration. Depending on how deeply (in the thickness) information is recorded in the 3D media, the signal read back changes, as illustrated in FIG. 11.

### Multi-Level Recording Work During Writing

FIG. 11(a) illustrates a micromagnetically simulated example of how each layer in a bit cell stack can be recorded in a patterned 3-D media in ML3D. In accordance with an exemplary embodiment, initially, a bit cell is assumed to be saturated. This means that the entire bit cell stack is magnetized in one direction (blue color). According to a trivial encoding scheme, this state may, for example, reflect a digital state “10”. Then, the recording field would be increased in the opposite direction to reverse the magnetization (red color) in the top layer. This state could reflect a digital “9”. When the field is further increased to the value overcoming the coercivity of the second (counting from the top) layer, the magnetization in the second layer is reversed. This state would reflect a digital “8”, and so on. The simulated recording field profiles in the first, second, and third layers, at an arbitrary current value in the recording transducer above the cell are shown in FIG. 11(b). It can be appreciated that other mechanisms, such as variation of the coercivity value across the media thickness, localized heating of sub-layers or/and sub-clusters, ferromagnetic resonance, and many others, can also be exploited/explored to achieve the same result.

ML3D Recording Work during Reading

In accordance with an embodiment, directly reading the stray magnetic field from a location above the media can accomplish the goal of the most readback operations. Similar to conventional magnetic recording, a giant magnetoresistive (GMR) or tunneling magnetoresistive (TMR) or another sensor can be used to read the magnetic field emanating from the media in the vicinity of each bit cell. In other words, this reading scheme reflects the ML3D recording mode, as described above (see FIGS. 11(a)-(b)). In this case, the net magnetic signal levels corresponding to various multilevel magnetization patterns could be illustrated by the magnetic “charge” configurations, as shown in FIG. 12(a). For example, for the totally saturated state (digital “10”), the net signal can consist of the magnetic field emanating from the “charge” on the top and bottom surfaces of the effective magnetic layer, respectively. For each intermediate state (“9”, “8”, etc), there is also contribution from the “charge” in the respective boundary plane 1210, as shown in FIG. 12(a). According to this magnetic “charge”, it can be appreciated that the net field for different magnetization patterns can be calculated. Thus calculated signal levels are shown in FIG. 12(b). It can be observed that the signal exponentially drops with the increase of the number of recording layers. It can be appreciated that the net signal-to-noise-ratio (SNR) depends not only on the read sensor (GMR, and others) but also on the media transition and dc noise and the electronic noise in pre-amplifiers. The calculated SNR versus the number of layers for a simplified case is shown in FIG. 12(c). In accordance with an exemplary embodiment, the media can be ideally patterned in all three directions and thus the media noise could be neglected. In addition, it can be appreciated that two sources of the electronics noise: 10 Ohm GMR sensor and 0.2 nV/sqrt (Hz) preamp noise over a 500 MHz CTF bandwidth at 1 Gigabit/sec data rate. In accordance with an embodiment, it is believed that more advanced encoding software channels (e.g., turbo) can reduce the bit error rate (BER) to 10⁻⁹ even for a 10 dB SNR recording system. According to an exemplary embodiment, even with such advanced encoding, only four to five layers (equivalent to 16 to 32 signal levels, respectively) can be distinguished in such a trivial implementation of 3-D recording. Fortunately, this is not a fundamental limit, since there are other solutions that can substantially improve the SNR characteristics of a 3-D system. For example, in accordance with an exemplary embodiment, optimization of the 3-D media and the use of differential sensors can be exploited and/or explored to further increase SNR, or alternatively, this problem can be solved on the system level, which is the subject of the current invention.

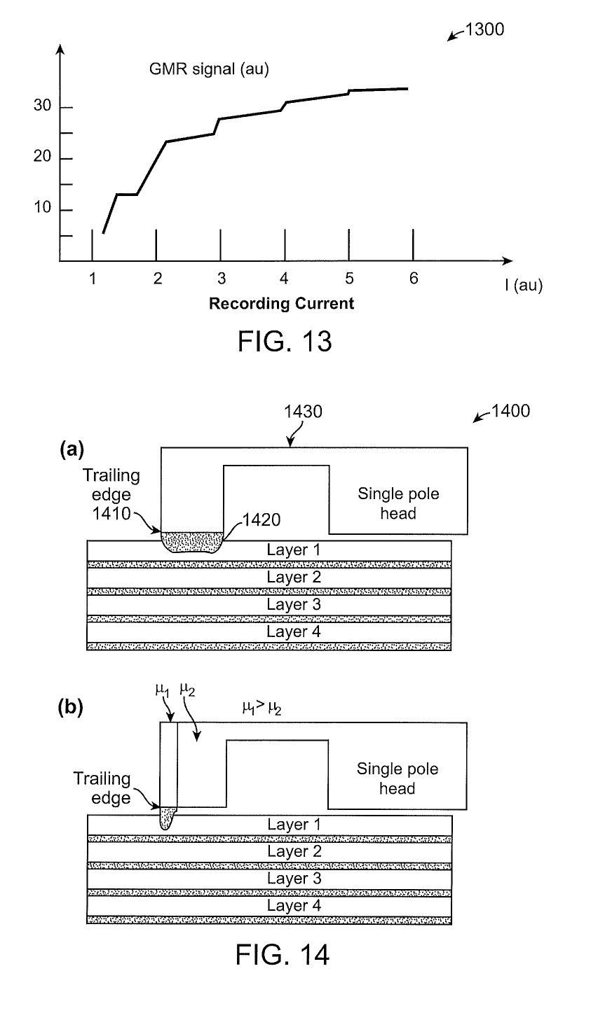

As a result, the signal levels read back from different information states are not clearly distinguished from each other if the number of levels exceeds approximately 5, as shown in FIG. 13. It can be appreciated that in accordance with an embodiment, the implementation of ML3D can be defined as “strong degradation of SNR with increasing the number of signal level above five or so.” In accordance with an exemplary embodiment, one approach is to design all the components of a ML3D recording system to increase the net SNR and maximize the number of utilized signal levels.

### Embodiment Number 1

In accordance with an exemplary embodiment, to increase the strength and the trailing gradient of the recording field, a high-permeability layer 1410 can be added to the trailing edge 1420 of the pole of the head 1430, as shown in FIG. 14. As explained below with the help of an equivalent magnetic circuit model, in this case, the recording field can be made substantially greater and sharper under the trailing edge compared to the rest of the air bearing surface (ABS) of the pole. Here, it should be reminded that in recording systems with spinning disks information is recorded by the trailing edge 1420 of the recording field. Therefore, it is important to make the field as strong and sharp as possible right next to the trailing edge of the pole. The strength of the field is also important for the particular 3D implementation in which the recording field should be able to exceed the coercivity of the bottom layer of the 3D recording media. In other words, the stronger the field is the deeper in the media it can penetrate. In addition, it is important to have the field profile relatively narrow to avoid the well-known problem of the skew angle sensitivity in any recording system which uses a single pole head and a recording media with a perpendicular orientation of the magnetization. The current invention addresses a 3D implementation with a perpendicular orientation of the magnetization.

In accordance with an exemplary embodiment, a recording head is disclosed having different values of relative magnetic permeability (not magnetic moment) between the two magnetic layers. Particularly, as explained below, the permeability of the trailing layer (Layer 1) should be substantially higher than the permeability of the leading layer (Layer 2). For example, as described below, varying the permeability of a soft magnetic material, e.g. Permalloy (Ni/Fe 81/19), during the deposition process can be obtained by just slightly changing the deposition conditions. For example, if sputtering is used to deposit Permalloy films, by slightly changing chamber pressure or deposition temperature or cooling condition, one can vary the relatively permeability from 200 to over 10,000. In accordance with an alternative embodiment, to change the saturation magnetization one might need to use a totally different material as the trailing layer. It can be appreciated that in general, over 100 distinct layers can be used, with each magnetic layer (or sublayer) in the recording media approximately 1-2 nm thick. In addition, the thickness of the trailing layer can vary from approximately 10 nm to 200 nm depending on the targeted areal density and the number of layers to be accessed during writing.

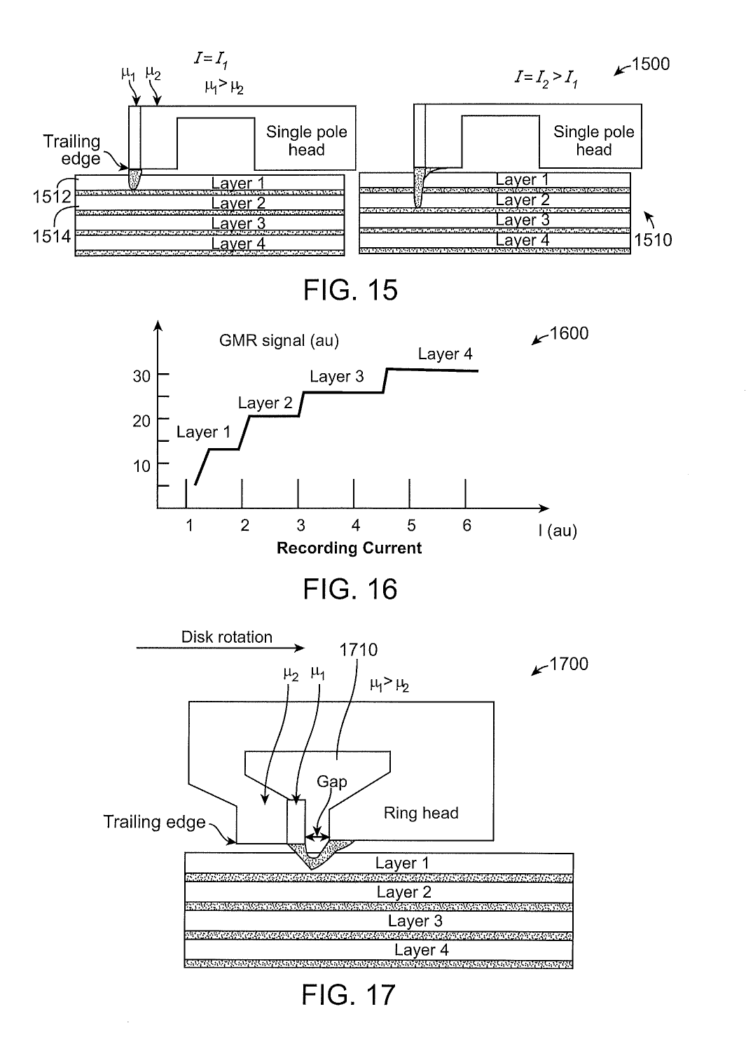

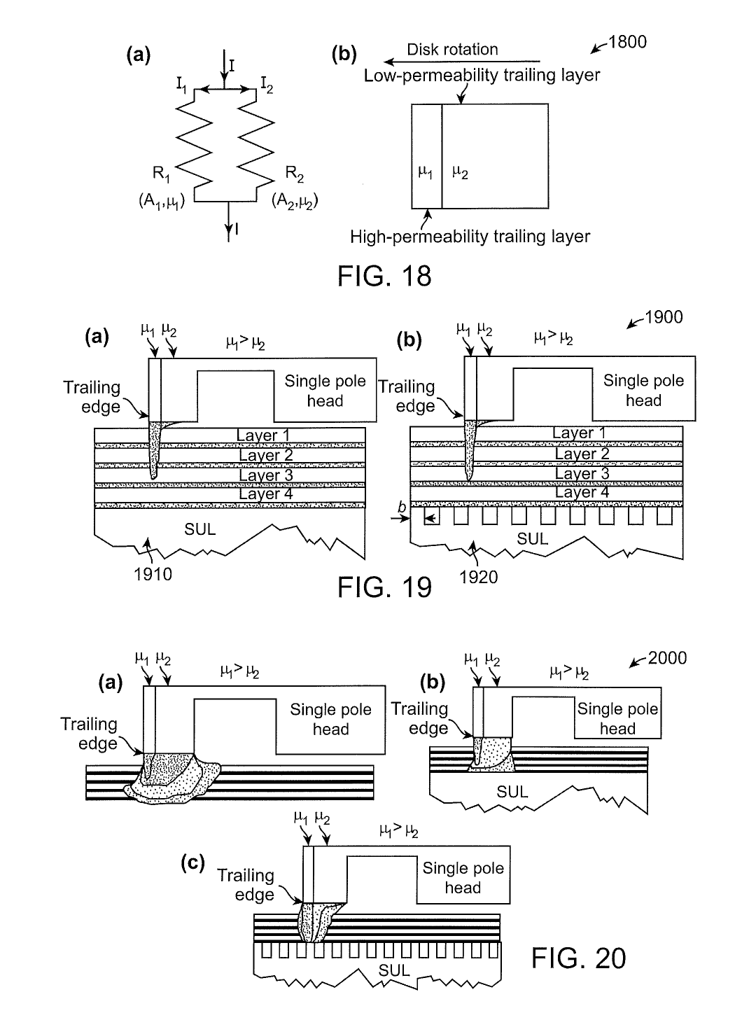

The mechanism of accessing different layers across the thickness of 3D media 1500 can be obtained by gradually increasing the current through the drive coil 1510 the field reaches deeper layers in the recording media 1500, as illustrated in FIG. 15. As the current is increased to the value I₁ the recording field exceeds the coercivity in Layer 1 (or “penetrates” in Layer 1) 1512. As the current is further increased, consequently the field is increased to exceed the coercivity of the media in Layer 2, i.e. the field “penetrates” in Layer 2 1514. In this manner, the information can be recorded in the most bottom layer (or sublayer) in 3D media as long as the recording field can exceed the coercivity of the layer.

To illustrate the concept, in accordance with an exemplary embodiment, a single pole head illustration was used. It can be appreciated that the concept is valid also for the ring head case. Again, the single pole head is best used with a recording media with a soft underlayer. The ring head works well both with and without a soft underlayer. It can be appreciated that the information along a track is recorded by the trailing edge of the recording field because the trailing edge is the last part of the head “seen” by any location along the track in the media as the disk spins under the head. The dark color (dark red color) in the figures indicates the regions in which the recording field exceeds the coercivity in the media. Also, it should be noted that for the simplicity of the description, it was assumed that the layers (or sublayers) of the recording media have uniform properties, i.e. have the same coercivity value. However, it can be appreciated that in accordance with another exemplary embodiment to further enhance this effect, a gradient of the coercivity across the thickness, i.e. variation through different layers (or sublayers), can be created as described above.

In accordance with an exemplary embodiment, the dependence of the recording field on the drive current for the above described four-layer 3D recording system with a laminated pole structure is shown in FIG. 16. It can be appreciated that in accordance with an exemplary embodiment, the presentation of signal levels compared with FIG. 15 is a consequence of a much sharper and stronger recording field generated by the laminated pole head.

It can be appreciated that in accordance with an exemplary embodiment, the concept can be extended to 3D media with over 100 layers.

In accordance with an exemplary embodiment, the three-dimensional (3D) media and recording head parameters preferably are within the following ranges:

a. The two magnetic layers (i.e., recording head and trailing edge) of the recording head in the head pole are preferably made of one or more soft magnetic materials with different values of the relative permeability. To accomplish the change of the permeability, one can either use different materials with different permeability values or the same material type with different values of permeability. The latter is definitely a substantially more cost-effective solution. For example, one can use the popular soft material Permalloy (Ni/Fe-81/19). It is a very straightforward task to vary the permeability in layers during sputter deposition process via variation of sputtering conditions, e.g. pressure, temperature, cooling condition, etc. Via such straightforward methods, the value of the relative permeability could be controllably changed from few hundreds to over tens of thousands. Optionally, other soft materials could be used: high moment Fe/Co compositions, high moment alloys such as FeAlN, FeTaN, and others.

b. The thickness of the trailing (i.e., trailing edge) and leading layers (recording head), i.e., Layers 1 and 2, respectively, in accordance with an exemplary embodiment are preferably in the ranges of approximately 50-200 nm and approximately 1-10 pin, respectively, depending on the number of the recording layers in 3D media and the targeted surface density. For example, for a 50-layer 3D media (with the thickness of each pair of magnetic and separation layers of approximately 2 nm), wherein the relative permeability of the trailing and leading layers to be approximately 2,000 and 100, respectively, the saturation magnetization of 2.4 T for both layers, the trailing and leading layers are preferably approximately 200 nm and 5 μm thick to achieve the areal density above 10 Terabit/in².

c. In accordance with an alternative embodiment, the materials of the trailing (i.e., trailing edge) and leading layers (recording head) can be made of different materials. For example, the higher moment material for the trailing layer will provide the higher achievable saturation recording field. Approximately, the saturation (meaning maximum) recording field scales with the saturation magnetization of the utilized material. The alternative materials for the trailing layer could be high moment Fe/Co compositions, high moment alloys such as FeAlN, FeTaN, and others.

d. The thickness of the trailing pole or trailing edge (Layer 1) in accordance with an exemplary embodiment is preferably in the range from 50 nm to 200 nm to minimize the skew angle sensitivity. The skew angle is preferably avoided especially with the use of single pole head.

e. The thickness of each magnetic layer in the 3D recording media is preferably in the range of 1 to 5 nm.

f. In accordance with an exemplary embodiment, the magnetic recording layers in the 3D media can be made of any magnetic recording material. Layers can be all of the same composition, or different compositions can be used for each layer. In accordance with an exemplary embodiment, the recording layers can comprise stacks of coupled Co/Pd or Co/Pt multilayers, with one or more coupled pair in each layer. Co and Pd (or Pt) thickness in each coupled layer can range from approximately 0.1 to 40 nm. In addition, it can be appreciated that the thicknesses of the Co and Pd (or Pt) does not have to be identical and/or coincide. For example, in accordance with an exemplary embodiment, the magnetic layers in the 3D media (where the information can be separately recorded) can be made of Co/Pd or Co/Pt multilayers, with one or more pairs in each layer, with Co and Pd (or Pt) layers ranging from 0.1 to 2.0 nm.

In accordance with a further embodiment, the magnetic recording layers can further comprise cobalt and chromium based materials, for example, such as that described in: Magnetic properties and read/write characteristics of Co—Cr—(Pt,Ta)/(Cr—Ti,Cr) thin film media, Shiroishi et al, Journal of applied physics: Annual conference on magnetism and magnetic materials, 73: 5569 (1993); Magnetic Properties and Recording Characteristics of Co—Cr—Ta—Pt Thin Film Media, Toshio et al., Japanese Journal of Applied Physics, Volume 32, Issue 9R, pp. 3823 (1993); Preparation of Co—Cr—Pt alloy film with high perpendicular coercivity and large negative nucleation field, Keitoku et al., Journal of Magnetism and Magnetic Materials, Volume 235, Number 1, October 2001, pp. 34-39; Perpendicular Co—Cr magnetic recording media prepared by sputtering using ECR microwave plasma, Yamamoto et al., Magnetics, IEEE Transactions on, Volume 32, Issue 5, September 1996 Page(s):3825-3827; Magnetic energy distribution in polycrystalline sputtered CoCr magnetic thin films, Al-Sharab et al., EPJ. Applied 2008, vol. 42, no 2, pp. 125-128; Zero magnetostriction Fe—Co—Cr magnetic recording media, U.S. Pat. No. 4,396,575; and Magnetic thin film material for magnetic recording, U.S. Pat. No. 5,560,786 (Co—Cr—P—Pt or Co—Cr—P—Ni), each of which is incorporated herein by reference in its entirety.

In accordance with an exemplary embodiment, the magnetic recording layers may further comprise one or more stacked CoCrPt/Pd or CoCrPt multilayers.

In accordance with another exemplary embodiment, the magnetic recording layers can comprise Fe—Pt materials in the L10 phase as described in Monodispersed and highly ordered L10 FePt nanoparticles prepared in the gas phase, Qui et al, Applied Physics Letters, Volume 88, Issue 19, id. 192505 (2006); Magnetic and structural properties of L10-FePt from a viewpoint of high-density recording media, Okamota et al., Nippon Oyo Jiki Gakkai Kenkyukai Shiryo, 139: 95-103 (2005); Growth of L10 ordered FePt alloy films at reduced temperatures, Martins et al., physica status solidi, 201: 837 (2004); L10 ordered FePt based double-layered perpendicular recording media with (002) oriented FeCo films as a soft magnetic underlayer, Hu et al., Thin Solid Films, 8: 2067-2070 (2008); and Crystallography of ordering studies of the L10 phase transformation of FePt thin film with Ag top layer, Zhao et al., J. Appl. Phys. 95: 7154-6 (2006), each of which is incorporated herein by reference in its entirety.

g. The separation layers in the 3D media can be made of non-magnetic materials such as Pd, Pt, Ti, Ta, Cu, Au, Ag, MgO, ITO, or/and other materials.

h. The separation layers in the 3D media could be made also of other magnetic materials to break the exchange coupling between the recording layers. In accordance with an exemplary embodiment, the magnetic materials should be different from the magnetic materials of which the recording layers are made. The thickness of the separation layer can vary from 0.3 to over 5.0 nm depending on the material used. For example, with Pd, the thickness of 1 nm is sufficient to substantially reduce the exchange coupling between adjacent Co/Pt (or Co/Pd) layers.

i. As a design guideline for defining the thicknesses of the magnetic and non-magnetic layers in 3D media, in accordance with an exemplary embodiment, one can follow the principle of minimizing the net thickness of the 3D media. With increasing the thickness of 3D media, the strength and the gradient of the recording field is sacrificed in the remote (from the transducer) layers.

j. In accordance with an exemplary embodiment, and as earlier mentioned, a single pole head is preferably used in combination with a media with a soft underlayer. The soft underlayer can be implemented in continuous as well as patterned forms.

k. The implementation with a ring head in accordance with an embodiment is similar to the implementation with a single pole head, with the exception of the direction of the change of the magnetic permeability. In the ring head case 1700, information is recorded by the trailing edge of the field emanating from the gap 1710. As a result, the layer with the highest permeability is preferably positioned closest to the gap 1710, as illustrated in FIG. 17. It could be noted that in the most trivial implementation, only the trailing pole of the ring head is preferably laminated. It can be appreciated that one of the reason for this is again the fact the information is recorded only by the trailing edge of the recording field.

In accordance with another exemplary embodiment, the relative magnetic permeability in different layers in the multilayered pole of the recording head is preferably varied. To simplify the description, the concept is described on the example of two magnetic layers only.

### The Physics Underlying the Invention—Equivalent Magnetic Circuit Model

It can be appreciated that in accordance with an exemplary embodiment, that with two different magnetic layers in the pole of a single pole head (with a media with a soft underlayer) is to provide an analytical model to explain the physics underlying the above described transducer design for multilevel 3D (ML3D) recording system. As described above, according to an exemplary embodiment, the trailing pole is preferably made of more than one magnetic layer, with the highest permeability magnetic layer at the trailing edge (for the single pole head and the other way around for the ring head), so that the highest flux density (field) can be concentrated near the trailing edge and thus a relatively sharp field profile could be created in the trailing edge. It can be appreciated that the field next to the trailing edge of the head is used to record information in the spinning disk. The narrow field profile is especially beneficial when a media with a soft underlayer is used and is a means of minimizing the destructive skew angle effect.

If only two layers (with two different values of permeability) are used, the high permeability layer (with permeability μ₁) is used to concentrate the magnetic flux at the trailing edge, while the low permeability layer (with permeability μ₂) provides a parallel path for the flux to flow. To describe this effect, the following equivalent magnetic circuit model (often called reluctance model) can be used. The two parallel paths can be represented as two reluctances, R₁ and R₂, connected in parallel, as shown in FIG. 17. Here, R₁=L₁/A₁μ₁ and R₂=L₂/A₁μ₂, where L and A are the length and the cross-sectional area and μ is the relatively magnetic permeability of a reluctance, the indices of 1 and 2 corresponding to the first and second paths, respectively. The reluctance in the magnetic circuit is equivalent to the resistance in the equivalent electric circuit. According to the equivalent reluctance model, the magnetic flux and flux density (field) are equivalent to the electric current and the current density, respectively. From the model, one can derive that J₁/J₂=μ₁/μ₂, where Jᵢ and J₂ are the flux densities in the two parallel branches, respectively. In other words, J₁/J₂=μ₁/μ₂, where H₁ and H₂ are the field values in the trailing and leading layers, respectively. From this simple analysis, it can be appreciated that one can conclude that the layer with the higher permeability will have the higher field. In the case of ideal perpendicular recording with a SUL, the field profile within the pole will be reflected also in the region in the recording media and therefore is used for recording information. However, this analysis is valid only as long as both layers within the laminated pole can be treated as soft magnetic materials, which is true until saturation modes kick in. In accordance with an exemplary embodiment, the goal is to drive the pole tip into saturation so that the maximum possible field can be generated to record information into a high-anisotropy media. The recording field remains high in the relatively small region defined mostly by the thickness of the high-permeability layer, while the relatively thick low-permeability layer acts as an adequate flux guide (to maintain sufficiently high efficiency of the system). The recording field under the low-magnetization layer can be tuned to be smaller than the coercivity of the recording media and therefore would not participate in the recording process.

### Embodiment Number 2

In accordance with another exemplary embodiment, the above described laminated transducer design with a 3D media 1900 with a soft underlayer (SUL) 1910 and with a patterned soft underlayer 1920, is illustrated in FIGS. 19(a) and (b), respectively. It can be appreciated that both continuous and patterned SUL can be made of typical soft magnetic materials, e.g. Permalloy (Ni/Fe 81/19), a high-moment Fe/Co alloy, FeAlN, ferrites, and many others). To pattern a SUL, all the typical nanofabrication tools can be used. These include photolithography, UV photolithography, electron-beam lithography, imprint lithography, focused ion beam (FIB) based fabrication, self-assembly, and others. It can be appreciated that according to the mirror image model, the use of a continuous or patterned SUL can increase the recording field by a factor of two or five, respectively, thus allowing to use a substantially thicker 3D media. In turn, the thicker recording media results in the proportional increase of the number of magnetic layers and thus the net information capacity.

It can also be appreciated that the use of a patterned SUL can not only substantially increase the recording field but also provides a much sharper field profile across the entire thickness of the recording media. In fact, the localization region is defined by the length b of each island in the patterned SUL 1920, as shown in FIG. 19(b). It can be appreciated that this feature is especially important for the current embodiment with 3D recording media which tends to be thicker than the average media in a conventional 2D recording system. FIG. 20 illustrates the concept 2000 of focusing the field profile across the thickness of the 3D media using a patterned SUL.

In addition, in certain conditions (depending on the curvature of the patterned islands and others) will result in having the maximum recording field being created in the bottom layer, which can be contrary to the conventional case when the recording field has its maximum in the top layer and goes down to its minimum in the bottom layer of the recording media. It can be appreciated that such reversing of the recording field profile across the thickness of the media can be beneficial in cases when the information needs to be first recorded in the top layer.

Principles of Writing Information into 3D Media

### A. Single-Scan Recording

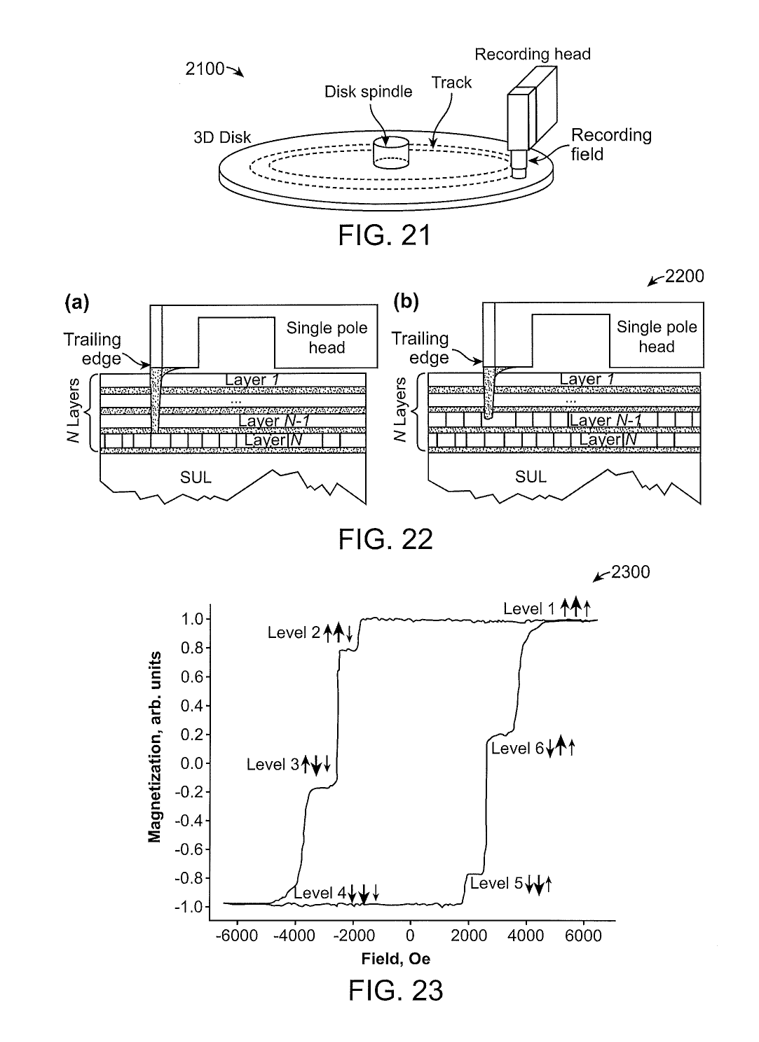

It can be appreciated that one of the ways to record information into 3D media is to use a single-scan method because it requires only one or two scans (spins) to record information into a track. The single-scan method relies on continuously varying the drive current during one scan (spin) along a track to vary the depth of penetration in layers in the 3D media. The statement “reaching a certain layer in 3D media” implies that the recording field in the layer has exceeded the coercivity value and therefore is sufficient to reverse the magnetization as required for recording information. This mechanism was described in more detail above and is also illustrated in FIG. 11(a). The schematic in FIG. 21 can help understand the definition of a track in a recording system 2100. In accordance with an exemplary embodiment, the number of signal levels read back in the single-scan mode should be equal to the number of magnetic layers, N.

### B. Multiple-Scan Recording

In accordance with another exemplary embodiment, each track is scanned N times where N is the number of magnetic layers in the 3D recording media. To identify each layer during the writing process, a certain electric current is driven through the drive coil. The value of the current is chosen to generate a recording field higher that the coercivity field in the respective layer. As described earlier, continuous and patterned SULs under the recording media could be used to further increase the recording field and thus the number of accessible magnetic layers in 3D media. Also, it can be appreciated that most recording systems are designed so that the field drops away from the recording head. As mentioned above, the exception to this rule is the case with a certain patterned SUL where the recording field has its maximum at the bottom layer of the 3D media, i.e. the layer closest to the SUL. For simplicity, the description below is related to the conventional cases only.

In accordance with an exemplary embodiment, information in different layers is recorded sequentially, layer after layer starting with the bottom layer of the media (as “seen” by the head). As a result, to record information in each track, the disk has to spin N times under the recording head. To be exact, N+1 times because there is one initial “reset” spin to “erase” all the information in the track. “Erasing” implies magnetizing the entire track in one direction. During the first recording spin (after the initial “reset” spin), the recording field is kept strong enough to record information in the bottom layer, i.e. Layer N. During the second spin, the field is reduced to the value sufficient to overcome the coercivity in Layer N−1 however smaller than the coercivity in layer N. This assures that new information is recorded in Layer N−1 and the previously recorded information in Layer N is intact. In a similar way, information can be recorded in Layers N−2 and all the way to Layer 1, as illustrated in FIG. 22.

Another form of recording information in the multi-scan mode is to sequentially record different layers in a certain sector (instead of a track) of the disk. Depending on specific applications, different forms of recording might be preferred. From the above description, it is clear that the number of signal levels achieved in the multi-spin recording mode will be 2^{N}, where N is the number of magnetic layers in 3D media.

### C. Full-Loop Two-Scan Recording

In accordance with another exemplary embodiment, the recording process relies on using a sophisticated hysteresis loop of ML3D media. Using this method ensures a predictable way to record all the possible signal levels in no more than two scans. To ensure reversibility of the recording process, every bit of the media should be magnetized in a certain order to complete the full hysteresis loop for the magnetic material of which the media is made. In other words, irreversible minor loops should be avoided. As an example, a full hysteresis loop of a three-layer ML3D measured via magneto-optical Kerr signal is shown in FIG. 23. One could see that the eight shoulders of the loop reflect eight possible magnetic states. The fact that the hysteresis loop is full implies that it does not take more than two steps to reach any chosen state. For example, to reach signal level (state) number 2, the large positive recording field is applied as the first step to saturate the media, and as the second step, the field is reversed to the value sufficient to reach the desired magnetic state. The same way, any other of the eight possible states can be reached. It can be appreciated that in the case of the described full-loop two-scan recording process, the number of achievable signal levels, S, is equal to 2*N, where N is the number of “exchange” decoupled magnetic layers. For example, for the above 3-layer ML3D media, the number of achievable signal levels is 6. For this particular case, it is a factor of two better than in the case of the most trivial recording mode, single-scan mode, in which the number of signal levels is always equal to the number of magnetic layers N. However, it is still not as good as the ideal recording in which the number of signal levels would be 2^{N}=2³=8.

### D. Minor-Loop Three-Scan Recording

In accordance with a further exemplary embodiment, this recording method relies on exploiting so called minor hysteresis loops. A schematic below illustrates the definition of minor loops. Again, for consistency and simplicity of the description, the 3D media consists of 3 layers only. However, it can be appreciated that in a preferred embodiment, the 3D media will consist of more than 3 layers.

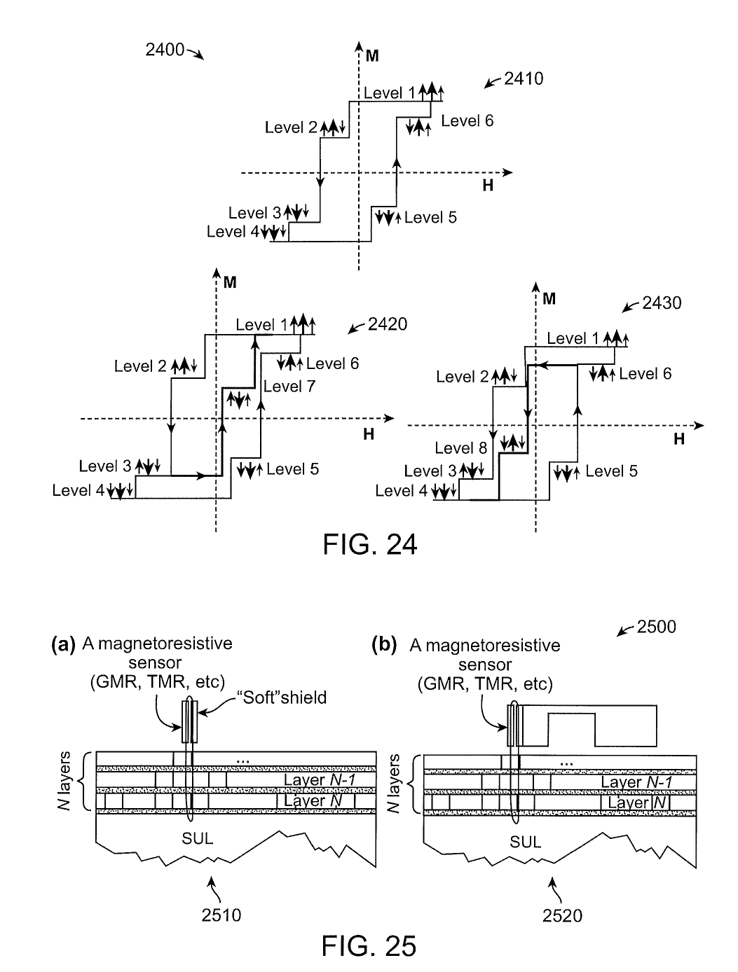

FIGS. 24(a)-24(c) illustrate the magnetization directions in the three layers of a S-layer ML3D media during a full hysteresis loop to choose levels 1 to 6 (2410), a minor loop to choose level 7 (2420), and a minor loop to choose level 8 (2430), respectively. The minor loops are shown by the red lines. In accordance with an exemplary embodiment, the blue, red, and green colored arrows stand for the three layers, respectively. The arrows along the hysteresis curves indicate the direction of the magnetic field. It can be seen that to initiate a minor hysteresis loop, a field reversal should be started before the full loop is closed, as illustrated in FIGS. 24(b) and (c).

The main idea behind exploring the minor loops is to initiate the signal levels which would not have been possible in the full loop. The number of signal levels which can be initiated using the minor-loop recording technique is 2^{N}, where N is the number of the magnetic layers in a 3D media.

Principles of Reading Information from 3D Media

The principles of reading were described above and illustrated in FIG. 12. In accordance with an exemplary embodiment, the reading mechanism will rely on directly reading the stray field emanating from a bit location on the surface of 3D media. Any conventional read element, using giant magnetoresistive (GMR), tunneling magnetoresistive (TMR) or another sensing method can be used to read the stray field. Moreover, a differential magnetoresistive sensor could be implemented to further increase SNR in a ML3D system.

### Embodiment 4

### Differential Reading of Information from 3D Media

In accordance with another exemplary embodiment, SNR in 3D media can be improved by at least a factor of two, and wherein reading 2500 with a differential method is especially beneficial for 3D recording systems. With the differential reading, a read element is positioned next to a magnetically soft film which creating a field shielding effect, which results in differential reading. In accordance with an embodiment, a trivial differential reader 2510 is shown in FIG. 25(a). Such reader consists of a pair of magnetic films which together act as a differential system. Either one or both of the elements in the differential reader should function as magnetoresistive elements (GMR, TMR, CPP, and others). The magnetoresistive element is necessary to convert the detected magnetic field into an electric signal while the presence of a pair is necessary for the cancellation effect, as described below. The high-permeability trailing pole of the single pole head could be used as one of the elements in the differential pair. In this case, the other element needs to be a magnetoresistive sensor 2520, as shown in FIG. 25(b).

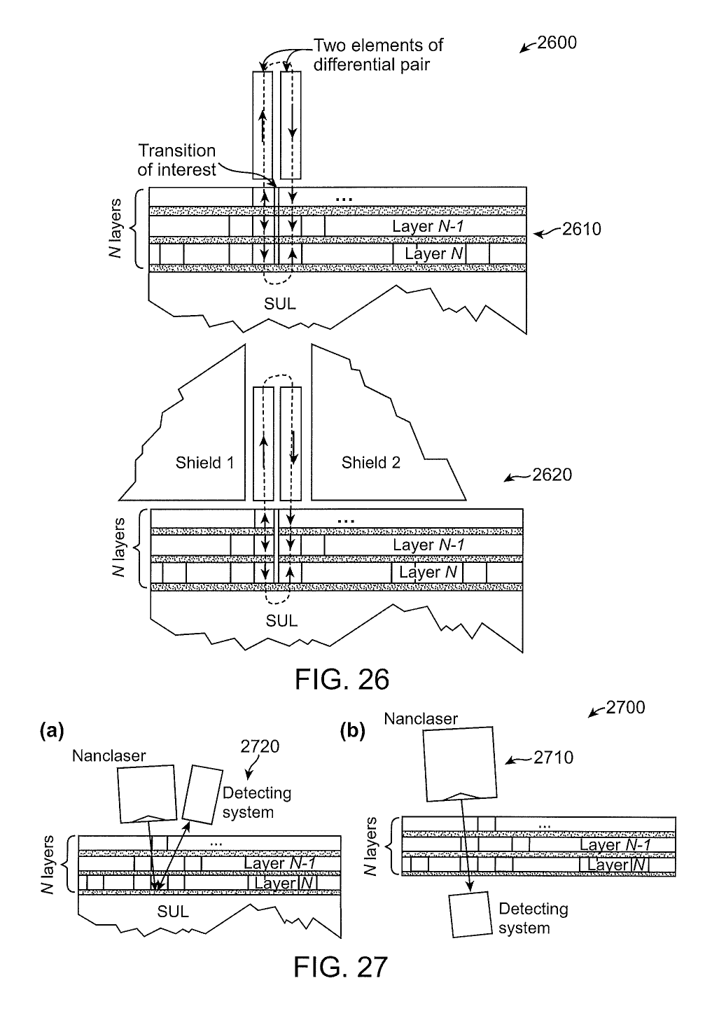

According to the differential reading concept, the stray signal coming from the transition of interest is amplified by approximately a factor of two, while the signal coming from other transitions in the media is cancelled out by the two main regions of the differential reader 2610, as shown in FIG. 26(a). Here, it should be reminded that in magnetic recording systems the signal read back comes from the transitions between two adjacent bit regions. To further cancel out the undesirable stray field from neighboring transitions, the differential pair can be further protected by two thick shields 2620, as shown in FIG. 26(b). This shielded configuration is used in conventional reading schemes as well. It can be appreciated that in general the potential number of signal levels will be 2^{N}, where N is the number of magnetic layers in 3D media.

### Embodiment 5

### Hybrid Design with Optical Reading

Though information in 3D media should be recorded by a magnetic field source, it can be read back optically. In accordance with an embodiment, one way to read magnetic information from a 3D disk is to use the magneto-optical Kerr effect. According to this effect, a polarized light which passes through a region in a magnetic media changes its polarization depending on the magnetization of the region. It can be appreciated that there are several options to implement such optical reading. In accordance with an embodiment, one can use near-field optical transducers (nanolasers) to control the power of highly focused light in a wide range from 0 to over 1 microwatt. For example, nanolasers can be used to focus light into a 25-nm spot. Ideally, with this technology, light can be focused into a spot size as small as 5 nm. In accordance with an embodiment, this technology provides for writing information in heat-assisted magnetic recording (HAMR) media suitable for ultra-high densities. In the current implementation, it can be appreciated that the same concept of focusing controlled amount of light power into such small regions can be used for the purpose of reading (instead of writing). The difference between the earlier proposed write scheme and the read scheme is in the power range of nanolasers. To avoid undesirable writing during reading, in accordance with an exemplary embodiment, one can use power values of less than 100 nW to focus light into a 25-nm spot. In this case, the locally heated temperature will not exceed Curie temperature for most materials used in magnetic recording and consequently any undesirable writing during the reading process would be avoided. The proposed optical reading 2700 can be implemented either in transmission 2710 or reflection mode 2720, as illustrated FIG. 27.

### Embodiment 6

### Gradient Reading Via Control of Softness of Soft Underlayer

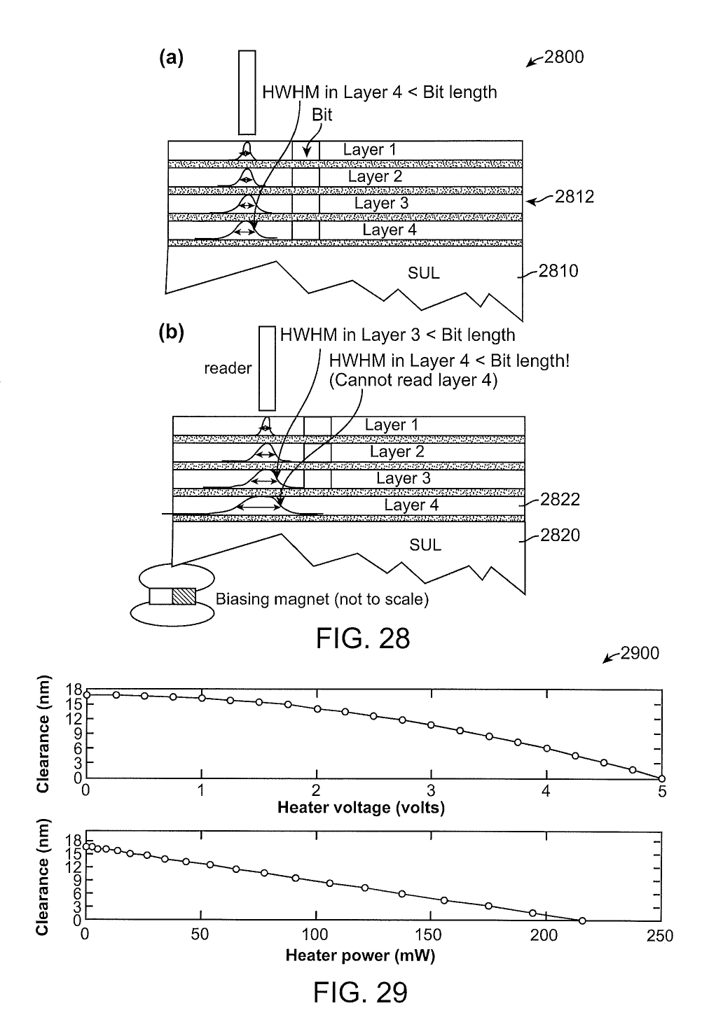

With either of the above reading mechanisms, the number of signal levels that could be read back is preferably still be less than approximately 1000. To further increase the number of signal levels that could be read back with adequate SNR, in accordance with another embodiment, the softness of a SUL can be varied, for example, by biasing it by another source of magnetic field (electric current through a wire or a set of wires nearby, by physically moving a permanent magnetic or a set of magnetic nearby, etc.). By doing this, the sensitivity field that defines the spatial resolution of a reading system 2800 changes, as illustrated in FIG. 28. With a perfectly soft SUL 2810, the sensitivity field across the media looks like it is shown in FIG. 28(a). As the SUL 2820 is biased, its softness can substantially decrease, as a result, the sensitivity field profiles look very different across the thickness. The half-width at half-maximum (HWHM) of the sensitivity field profile along a certain layer defines the smallest length (bit) which could be read back from the respective layer. To illustrate the point, the sensitivity field in the case of unbiased SUL 2810 “penetrate” through the entire stack of 4 layers 2812 (in this particular example), while the sensitivity field in the case of the biased SUL 2820 cannot “penetrate” (in other words, the HWHM in this layer is wider than the length of the bit) in layer 4 (2822). Now, if the signal in the biased case is subtracted from the signal in the previous (non-biased case), the difference signal will be equal to the information recorded in Layer 4 (2822).

This technique can be further extended to gradually read from all the layers (by subtracting the signal at each instance from the signal in the previous instance). In this case, the time instances should correspond to the steps of reading from two adjacent layers, respectively. In another exemplary embodiment, biasing can be performed by positioning a permanent magnet close to SUL. If the magnetic is gradually moved close to the SUL (through a mechanical fixture attached to an independent voice coil motor or a piezo-activated manipulator) so that its motion is matched with the timings of reading from adjacent layers, this operation could be used to read information from more than 10 magnetic layers (effectively providing much more than 1000 signal levels).

### Embodiment Number 7

### Thermally Controlled Fly Height

According to another exemplary embodiment, to create a multilevel configuration during writing, the recording field was varied via the variation of the drive current. Another way to achieve the same goal is to vary the separation between the head and the media (fly height) via the variation of temperature of the local environment between the head and the media. It can be appreciated that recently, a similar technique was developed in the data storage industry to maintain the fly height with an Angstrom precision. This technique is called thermal-fly-height adjust. In this implementation, a heater element is embedded in the head. The heater is used to controllably vary the spacing during both writing and reading. FIG. 29 illustrates a typical Spinstand experiment (2900) in which this technique is used to control the spacing in the range from 20 down to approximately 3 nm. Here, it should be noted that this experiment shows unprecedented reproducibility in the fly height control of approximately 0.5 nm. It can be noticed that the clearance is linear with the power and quadratic with the voltage in the heating element.

According to this particular multilevel implementation, in accordance with an exemplary embodiment, the propose of this mechanism is not to maintain the “fly height” with such a phenomenal precision, but rather to precisely control the separation and thus physically move the field profile in the vertical direction with the same unprecedented accuracy. This way, an ultra-precise control of the physical position of the recording head in a third dimension is achieved. This approach is independent of the earlier discussed approach based on the head's drive current variation. Nevertheless, it is of importance to explore the alternative approach because it has its advantages and concerns which are complementary to the first approach since the embodiment, does not require any essential system modification (adding SUL and especially a patterned SUL), and the unprecedented repeatability of less than 0.5 nm in maintaining the fly height.

In accordance with an exemplary embodiment, an acoustic emission (AE) sensor can be used to determine when the head hits the disk. As the head flies over the disk, the AE signal is monitored while the heater's power is increased. The AE signal then “tells” when the head and the disk start to touch. As long as the head/disk contacts are minimized, the repeatability of the measurement appears to be about 0.5 nm. To put this in perspective, the nominal flying height is about 11 nm. So, the error is about 5%, which is quite low for this type of measurement. The AE signal does not abruptly increase when the head and disk start to interact due to lube and other “plastic” deformations that occur at the interface. In fact, as practice shows, asperities and overcoats may be burnished off during prolonged contact. Finally, the control and repeatability of thermal flying height adjust are quite remarkable. In accordance with an embodiment, such a unique control of the fly height is used to create a multilevel signal configuration. The transducer with a micro-heater, as described above, will be used with a 3D media which was discussed above. Again, both approaches are complementarily. Finally, such fly height control can be used for both writing as well as reading multilevel information from 3D media.

For writing, by using this thermal control to physically move the recording head in a vertical direction, recording into different layers across the thickness of 3D media is achieved. Using this method, the effective separation between the head and the media could be controlled at least in the range from 0 to 200 nm. Therefore, layers in a 3D media with a net thickness ranging from a few nanometers to over 200 nm could be achieved. Considering that the thickness of each layer could be as small as 2 to 5 nm, the number of independent layers achieved could range from 100 to 40, respectively.

For reading, by using this thermal control to physically move the recording head in a vertical direction in the range from 0 to over 200 nm, the same gradient reading technique, as described above in Embodiment Number 6, could be used. In this case, instead of changing the softness of SUL, different layers across the thickness of 3D media are achieved as a result of the physical motion of the head in the vertical direction.

### Embodiment Number 8

### Multiple Write Heads on a Slider

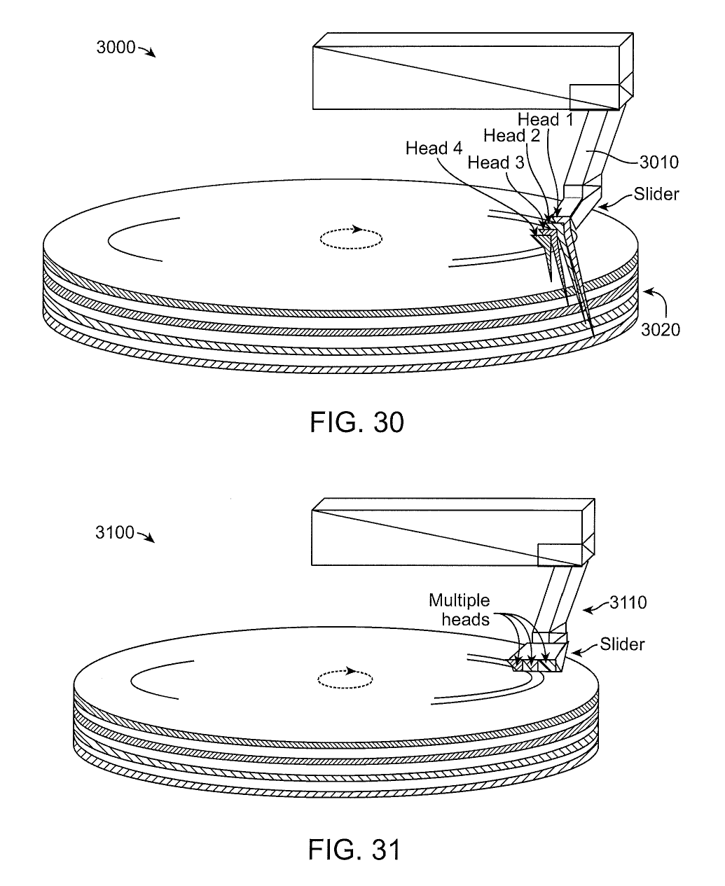

In accordance with another embodiment, to further increase the write data rate in ML3D system, in this embodiment to have multiple write heads (of the designs described above) to be positioned on a slider—the standard mechanical fixture used in a conventional drive to ensure a stable separation between the disk and the head. In accordance with an embodiment, the number of the recording heads positioned on the slider should be equal to the number of magnetic layers in ML3D media. In this case, each recording head 3010 is programmed to access a certain layer in the media 3000, as schematically illustrated in FIG. 30. The illustration is not to scale and exaggerated with the purpose to explain the concept. The concept is illustrated on an example with 4 magnetic layers. Therefore, four recording heads should be used. The heads 3010 should be positioned on the trailing edge of the slider one after another in the direction of the recording track. (For clarity of explanation, the four heads are shown as red, green, blue, and grey cones, respectively.) In this order, head 1 (the red head) is used to record in the most bottom layer and head 4 (the grey head) is used to record in the most top layer of the media. This order should be picked because head 1 and head 4 (the red head and grey heads) are first and last, respectively, to “see” any regions in the rotation disk. It is clear that the described embodiment can increase the write data rate by N where N is the number of the magnetic layers.

### Embodiment Number 9

### Multiple Read Heads on a Slider

In accordance with a further embodiment, a set of multiple read heads 3110 can be used to increase the data rate during reading. However, it can be appreciated that in this case, all the read heads should be positioned one after another in the direction across the track, as shown in FIG. 31. For simplicity only three heads are shown in the illustration. However, it can be appreciated that more than three heads can be used. In general over 100 read heads could be placed on a slider. Also, the number of read heads, M, is independent of the number of layers in the media, N. It should be understood that in this case, different heads just simultaneously read information from different tracks in ML3D media. Each head can be identical to any read head configuration as described above, in other words. The effective increase in the data rate during reading is by a factor of M.

To demonstrate the concept, in accordance with an exemplary embodiment, a 3D media with 3 magnetic layers was used. In accordance with an embodiment, a 3-layer media having 3 layers (or sublayers) was deposited by a standard method of co-sputtering. The layers (which are also referred to as stacks) includes a first layer (or bottom layer) of Pd(5 nm)/{Co(0.26 nm)/Pd(0.56 nm)}×10 layers, a second layer (or middle layer) of Pd(5 nm)/{Co(0.26 nm)/Pd(0.56 nm)}×7 layers; and a third layer (or top layer) of Pd(5 nm)/{Co(0.46 nm)/Pd(0.56 nm)}×2/Pd(5 nm) layers. The Co and Pd in each of the three stacks or layers (of 10, 7, and 2 pairs, respectively were deposited one after another in a very fast manner as a result of relatively fast rotation of the sample with respect to the circular holder with two targets)). It can be appreciated that the further away from the recording head a layer (or sublayer), i.e., stack, the weaker and more spread out the field profile will be in the region of the stack and therefore the recorded information would be noise. Accordingly, to compensate for the weakening of the field in the bottom layer (or stack), the number of layers in the layer (i.e., first layer or bottom layer) can be increased to maintain a certain signal-to-noise ratio, i.e., the more layers in a stack, the stronger the signal coming from the stack. The deposition rates were as follows: Co: 0.39 A/s under the 7.5% DC power, Pd rate: 0.45 A/s under the 2.5% DC power. The total DC power was approximately 750 W. The deposition environment was room temperature, 100% sample rotation. The pressure in the main Chamber was about 1E-8 Ton.

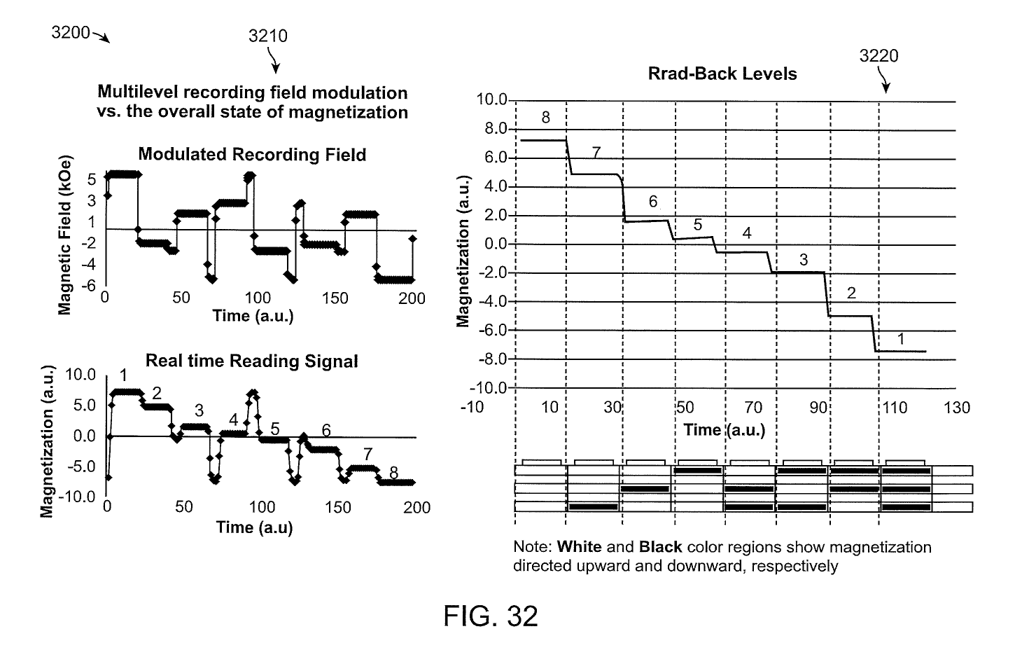

In accordance with an embodiment, ideally, 8 signal levels (states) were expected from this media configuration 3210, as illustrated in FIG. 32(a). To demonstrate that this system indeed results in 8 signal levels (states), the media was magnetized with a modulating field in order to generate all 8 signals. The Kerr signal read back from such 3D media is shown in FIG. 32(c). One can see the number of distinct signal levels is eight. In this case, the three magnetic layers are three sets of Co/Pd multilayers corresponding to a composition comprising of a first layer (or bottom layer) of Pd(5 nm)/{Co(0.26 nm)/Pd(0.56 nm)}×10 layers, a second layer (or middle layer) of Pd(5 nm)/{Co(0.26 nm)/Pd(0.56 nm)}×7 layers; and a third layer (or top layer) of Pd(5 nm)/{Co(0.46 nm)/Pd(0.56 nm)}×2/Pd(5 nm) layers, i.e., stacks of 10, 7, and 2 Co/Pd multilayers with a separation of about 5 nm decoupling layer.

The small discrepancy (measured 7 levels instead of predicted 8 levels) between the measurements and predictions is due to the fact that two signal levels (4 and 5 according to the illustration in FIG. 32(a)) appeared to be too close to each to be distinguished. These two levels (Levels 4 and 5 in FIG. 32(a)) could be further separated by changing the relative thicknesses of magnetic layers. Nevertheless, the experiment undeniably indicates the presence of at least 7 easily distinguishable signal levels.

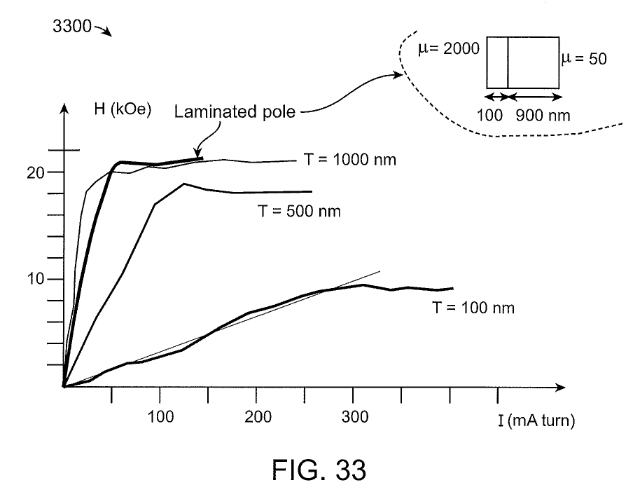

FIG. 33 is a characteristic graph 3300, which shows a numerical simulation of the recording field generated by four different recording poles with the same width of 60 nm, 1) green line: 1000-nm thick single layer pole (with permeability of 2000; 2) blue line: 500-nm thick single layer pole (with permeability of 2000; 3) red line: 100-nm thick single layer pole (with permeability of 2000; and 4) black line: a dual layer (a 100-nm thick layer with perm. of 2000 and a 900-nm thick layer with perm. of 50). In this graph, the maximum vertical recording for the four designs is shown as a dependence of the electric current through the drive coil around the pole.

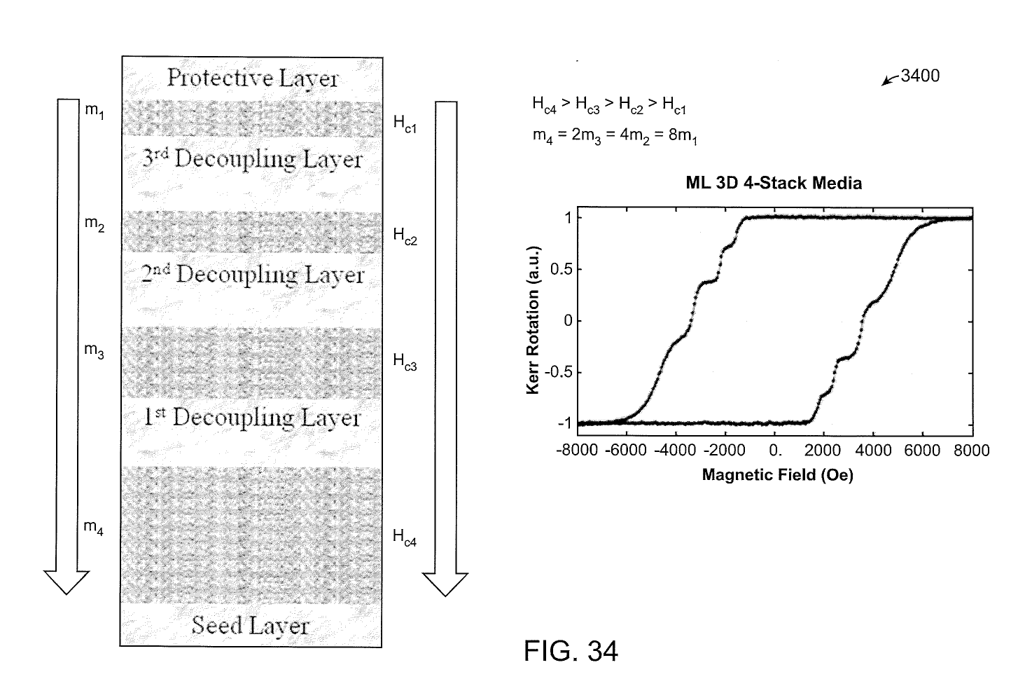

FIG. 34 is a schematic illustration showing the layer structure of 4 magnetically decoupled Co/Pd multilayers stacks 3400 in which the top layer has the lowest coercivity and magnetic moment and the bottom layer has the highest coercivity and the highest moment, and wherein the magnetic moment and coercivity are interchangeable and depend on the fabrication conditions (left), and a Kerr signal taken from a 4 layer media, which shows the characteristics of a 16 readback signal level media (right).

It will be understood that the foregoing description is of the preferred embodiments, and is, therefore, merely representative of the article and methods of manufacturing the same. It can be appreciated that many variations and modifications of the different embodiments in light of the above teachings will be readily apparent to those skilled in the art. Accordingly, the exemplary embodiments, as well as alternative embodiments, may be made without departing from the spirit and scope of the articles and methods as set forth in the attached claims.

What is claimed is:

1. A multilayered three-dimensional media comprising:
a plurality of magnetic sublayers, each of the magnetic sublayers being separated from one another by a non-magnetic layer; and
wherein each of the plurality of magnetic sublayers is a stack of one or more coupled Co/Pd or Co/Pt layers.

2. The media of claim 1, wherein a lower magnetic sublayer has a greater number of coupled Co/Pd or Co/Pt layers than an upper magnetic sublayer, and wherein the lower magnetic sublayer is further away from the recording head than the upper magnetic sublayer.

3. The media of claim 1, further comprising a soft underlayer disposed adjacent to the three-dimensional media.

4. The media of claim 1, wherein each of the non-magnetic layers are Pd, Pt, Ti, Ta, Cu, Au, Ag, MgO and/or ITO.

5. A multilayered three-dimensional (3D) recording system, comprising:
a three-dimensional (3D) media, the three-dimensional media includes a plurality of magnetic sublayers, wherein each magnetic sublayer is adapted for writing data to; and
a recording head having a trailing edge, and wherein the trailing edge has a higher permeability than the recording head.

6. The system of claim 5, wherein each of the magnetic sublayers is vertically stacked parallel to each other and separated from one another by parallel non-magnetic interlayers.

7. The system of claim 5, wherein the trailing edge has a thickness of approximately 10 nm to 200 nm, and wherein the thickness of the trailing edge depends on the targeted areal density and the number of magnetic sublayers accessed during writing.

8. The system of claim 5, wherein the recording head is a single pole head or a ring head.

9. The system of claim 5, wherein the recording head and the trailing edge are comprised of one or more soft magnetic materials with different values of relative permeability and wherein the relative permeability of the trailing edge is substantially greater than the relative permeability of the recording head.

10. The system of claim 5, wherein the trailing edge has a field strength, and wherein the field strength exceeds the coercivity of a bottom layer of the 3D magnetic media.

11. A method of writing information into a three-dimensional media comprising:
providing a three-dimensional media having a number of magnetic sublayers; and
writing data onto the three-dimensional media with a recording head by continuously varying a drive current during at least one scan along a track to vary the depth of penetration in the magnetic sublayers of the three-dimensional media, and wherein reaching a sublayer in the three-dimensional media is obtained by exceeding the coercivity value in the sublayer, which is sufficient to reverse the magnetization required for recording information.

12. The method of claim 11, further comprising recording information sequentially in different sublayers by starting with a bottom sublayer of the media as seen by the recording head.

13. The method of claim 11, further comprising sequentially recording different layers in a certain sector of the three-dimensional media.

14. The method of claim 11, further comprising reading a stray field emanating from a bit location on a surface of the three-dimensional media.

15. The method of claim 11, further comprising optically reading the data using a magneto-optical Kerr effect, wherein a polarized light passes through a region in the magnetic sublayers changes its polarization depending on the magnetization of the region.

16. The method of claim 11, further comprising biasing the soft underlayer with another source of magnetic field, such as an electric current through a wire or a set of wires nearby, by physically moving a permanent magnetic and/or setting a magnetic nearby.
